(19) United States
(12) Patent Application Publication
(10) Pub. No.: US 2022/0028385 A1
(43) Pub. Date: Jan. 27, 2022

(54) ELECTRONIC DEVICE FOR PROCESSING USER UTTERANCE AND METHOD FOR OPERATING THEREOF

(71) Applicant: Samsung Electronics Co., Ltd., Suwon-si (KR)

(72) Inventors: Dooho BYUN, Suwon-si (KR); Taekwang UM, Suwon-si (KR); Woonsoo KIM, Suwon-si (KR); Jaeyung YEO, Suwon-si (KR)

(21) Appl. No.: 17/449,878

(22) Filed: Oct. 4, 2021

Related U.S. Application Data
(63) Continuation of application No. PCT/KR2020/015073, filed on Oct. 30, 2020.

(30) Foreign Application Priority Data
Nov. 1, 2019 (KR) 10-2019-0138900

(51) Int. Cl. G10L 15/22; G10L 15/08

(52) U.S. Cl. CPC G10L 15/22; G10L 15/08

(57) ABSTRACT

According to various embodiments, a control operation of an electronic device may be provided, the control operation comprising the operations of: registering a plurality of voice assistants in a first category, wherein the plurality of voice assistants include information about a plurality of utterances processable by the plurality of voice assistants and result information corresponding to responses for the plurality of utterances; identifying the plurality of utterances processable by the plurality of voice assistants registered in the first category; identifying at least one common utterance, from among the plurality of utterances, that satisfies a specific condition related to a similarity; receiving a request for registering a first voice assistant in the first category from an external device; and providing information related to the at least one utterance to the external device based on the request. Other various embodiments are possible.

### CROSS-REFERENCE TO RELATED APPLICATIONS

This application is a continuation of International Application No. PCT/KR2020/015073, filed on Oct. 30, 2020, which claims priority to Korean Patent Application No. 10-2019-0138900, filed on Nov. 1, 2019, in the Korean Intellectual Property Office, the disclosures of which are herein incorporated by reference.

### BACKGROUND

### 1. Field

The disclosure relates to an electronic device that processes a user utterance and a method of operating the electronic device.

### 2. Description of Related Art

These days, portable digital communication devices have become a necessity in daily living. Consumers want to receive various high-quality services anytime, anywhere through their portable digital communication devices.

Speech recognition is a service that provides various content services to consumers in response to a received user speech based on a speech recognition interface implemented in a portable digital communication device. To provide the speech recognition service, technologies for recognizing and analyzing human languages (for example, automatic speech recognition, natural language understanding, natural language generation, machine translation, dialogue system, question answering, speech recognition/synthesis, and so on) are implemented in the portable digital communication device.

To provide a high-quality speech recognition service to consumers, it is necessary to implement a technology of providing a voice assistant capable of processing various user speeches.

### SUMMARY

An electronic device may provide various voice services to a user by processing an utterance received from the user through an external server. The external server may receive the user utterance from the electronic device and provide a specific service by processing the user utterance based on a voice assistant corresponding to the user utterance among a plurality of voice assistants for processing user utterances, registered to the external server. However, as user demands for various types of services increase, the number of utterances that a voice assistant should be able to process increases. Therefore, an operational load increases in training the voice assistant with utterances. When a new voice assistant is registered to provide a specific service, the operational load also increases in enabling the new voice assistant to process speeches provided by already-registered voice assistants. Moreover, as the number of voice assistants increases, it may be difficult to specify a voice assistant that provides a specific service corresponding to a user utterance among the voice assistants.

According to various embodiments, based on utterances processable by the voice assistants of a specific category, an electronic device may train other voice assistants of the specific category than the new voice assistant registered to the specific category and train the new voice assistant. Therefore, the efficiency of training a voice assistant may be increased. According to various embodiments, the electronic device may manage a plurality of registered voice assistants by category and identify a category corresponding to a user utterance and voice assistants included in the category, based on utterances processable by the voice assistants registered to the categories. Accordingly, a voice assistant providing a specific service may be identified with higher accuracy.

According to various embodiments, an operation of controlling an electronic device may include registering a plurality of voice assistants to a first category, the plurality of voice assistants including information about a plurality of capable of being processed utterances and a plurality of pieces of processing result information corresponding to the plurality of utterances, identifying the plurality of utterances capable of being processed by the plurality of voice assistants registered to the first category, identifying at least one common utterance among the identified plurality of utterances, the at least one common utterance satisfying a specific condition related similarity, receiving a request for registering a first voice assistant to the first category from an external device, and providing information related to the at least one common utterance to the external device, based on the request.

According to various embodiments, an operation of controlling an electronic device may include registering a plurality of voice assistants to a first category, the plurality of voice assistants including information about a plurality of utterances capable of being processed and a plurality of pieces of processing result information corresponding to the plurality of utterances, identifying the plurality of utterances capable of being processed by the plurality of voice assistants registered to the first category, identifying at least one common utterance corresponding to the first category based on the identified plurality of utterances, identifying that a specific condition for sharing the at least one common utterance has been satisfied, and based on the identification that the specified condition for sharing the at least one common utterance has been satisfied, providing information related to the at least one common utterance to at least a part of a plurality of external devices corresponding to the plurality of voice assistants registered to the first category.

According to various embodiments, an electronic device may include a communication circuit, a processor, and a memory. The memory may store instructions which when executed, cause the processor to register a plurality of voice assistants to a first category, the plurality of voice assistants including information about a plurality of utterances capable of being processed and a plurality of pieces of processing result information corresponding to the plurality of utterances, identify the plurality of utterances capable of being processed by the plurality of voice assistants registered to the first category, identify at least one common utterance among the identified plurality of utterances, the at least one common utterance satisfying a specific condition related to a similarity, control the communication circuit to receive a request for registering a first voice assistant to the first category from an external device, and control the communication circuit to transmit information related to the at least one common utterance to the external device, based on the request.

The technical solutions according to various embodiments are not limited to the above-described technical solutions. Those skilled in the art may clearly understand technical solutions which are not described herein from the disclosure and the attached drawings.

According to various embodiments, an electronic device and a method of operating the same may be provided, which increase the efficiency of training a voice assistant by training other voice assistants of a specific category than a new voice assistant registered to the specific category and training the new voice assistant, based on utterances processable by the voice assistants of the specific category. According to various embodiments, an electronic device and a method of operating the same may be provided, which increase the accuracy of identifying a voice assistant providing a specific service by managing a plurality of registered voice assistants by category and identifying a category corresponding to a user utterance and voice assistants included in the category, based on utterances processable by the voice assistants registered to the categories.

### BRIEF DESCRIPTION OF THE DRAWINGS

FIG. 1 is a block diagram illustrating an integrated intelligence system according to various embodiments.

FIG. 2 is a diagram illustrating storage of information about association between concepts and actions in a database according to various embodiments.

FIG. 3 is a diagram illustrating a screen on which a user equipment (UE) processes a speech input received through an intelligent app according to various embodiments.

FIG. 4 is a diagram illustrating an exemplary configuration of an intelligence system according to various embodiments.

FIG. 5 is a diagram illustrating an exemplary configuration of an intelligent server according to various embodiments.

FIG. 6 is a flowchart illustrating an exemplary operation of an intelligent server according to various embodiments.

FIG. 7 is a diagram illustrating an exemplary operation of identifying at least one common utterance in an utterance data analysis module of an intelligent server according to various embodiments.

FIG. 8 is a diagram illustrating an example of utterances processable by a plurality of voice assistants included in a specific category according to various embodiments.

FIG. 9 is a diagram illustrating an exemplary operation of receiving a request for registering a specific voice assistant to a specific category from another device in an intelligent server according to various embodiments.

FIG. 10 is a flowchart illustrating an exemplary operation of an intelligent server according to various embodiments.

FIG. 11 is a diagram illustrating an exemplary operation of identifying that a specified condition has been satisfied in an intelligent server according to various embodiments.

FIG. 12 is a flowchart illustrating an exemplary operation of identifying whether a common utterance is supported and processing the common utterance according to the identification in an intelligent server according to various embodiments.

FIG. 13 is a diagram illustrating an exemplary operation of identifying whether a common utterance is supported and processing the common utterance according to the identification in an intelligent server according to various embodiments.

FIG. 14 is a diagram illustrating an exemplary interface through which it is identified whether a common utterance is supported in an intelligent server according to various embodiments.

FIG. 15 is a flowchart illustrating exemplary operations of an electronic device and an intelligent server according to various embodiments.

FIG. 16 is a diagram illustrating an exemplary operation of receiving information about a category from an intelligent server in an external device according to various embodiments.

FIG. 17 is a flowchart illustrating exemplary operations of an intelligent server, an electronic device, and a developer server according to various embodiments.

FIG. 18 is a diagram illustrating an exemplary operation of receiving information about an utterance, for training, from an electronic device in an intelligent server according to various embodiments.

FIG. 19 is a diagram illustrating an exemplary operation of receiving information about an utterance, for training, from a developer server in an intelligent server according to various embodiments.

FIG. 20 is a block diagram illustrating an electronic device in a network environment according to various embodiments.

### DETAILED DESCRIPTION

Before a description of various embodiments, an integrated intelligence system will be described below.

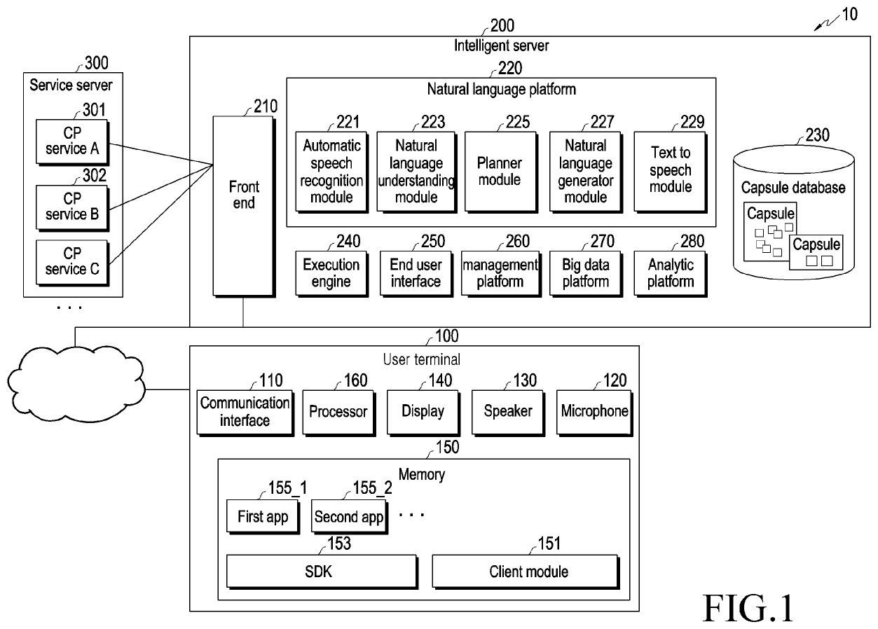

FIG. 1 is a block diagram illustrating an integrated intelligence system according to various embodiments.

Referring to FIG. 1, an integrated intelligence system 10 according to an embodiment may include a user equipment (UE) 100, an intelligent server 200, and a service server 300.

The UE 100 according to an embodiment may be a terminal device (or electronic device) connectable to the Internet. For example, the UE 100 may be a portable phone, a smart phone, a personal digital assistant (PDA), a laptop computer, a TV, a major appliance, a wearable device, a head-mounted display (HMD), or a smart speaker.

According to the illustrated embodiment, the UE 100 may include a communication interface 110, a microphone 120, a speaker 130, a display 140, a memory 150, or a processor 160. These components may be operatively or electrically coupled to one another.

The communication interface 110 according to an embodiment may be connected to an external device and configured to transmit and receive data to and from the external device. The microphone 120 according to an embodiment may receive a sound (for example, a user utterance) and convert the sound to an electrical signal. The speaker 130 according to an embodiment may output an electrical signal as a sound (for example, a speech). The display 140 according to an embodiment may display an image or a video. The display 140 according to an embodiment may display a graphical user interface (GUI) of an executed app (or application program).

The memory 150 according to an embodiment may store a client module 151, a software development kit (SDK) 153, and a plurality of apps 155. The client module 151 and the SDK 153 may form a framework (or solution program) to execute a general-purpose function. Further, the client module 151 or the SDK 153 may form a framework to process a speech input.

In the memory 150 according to an embodiment, the plurality of apps 155 may be programs for executing specified functions. According to an embodiment, the plurality of apps 155 may include a first app 155_1 and a second app 155_3. According to an embodiment, each of the plurality of apps 155 may include a plurality of operations for executing the specified functions. For example, the apps may include an alarm app, a message app, and/or a scheduling app. According to an embodiment, the plurality of apps 155 may be executed by the processor 160 to sequentially execute at least some of the plurality of operations.

The processor 160 according to an embodiment may provide overall control to the UE 100. For example, the processor 160 may be electrically coupled to the communication interface 110, the microphone 120, the speaker 130, and the display 140 and perform specified operations.

The processor 160 according to an embodiment may also execute a program stored in the memory 150 to execute a specified function. For example, the processor 160 may execute at least one of the client module 151 or the SDK 153 to perform the following operations for processing a speech input. The processor 160 may control the operations of the plurality of apps 155, for example, through the SDK 153. The following operations described as performed by the client module 151 or the SDK 153 may be performed by the processor 160.

The client module 151 according to an embodiment may receive a speech input. For example, the client module 151 may receive a speech signal corresponding to a user utterance detected through the microphone 120. The client module 151 may transmit the received speech input to the intelligent server 200. The client module 151 may transmit state information about the UE 100 together with the received speech input to the intelligent server 200. The state information may be, for example, information about the execution state of an app.

The client module 151 according to an embodiment may receive a result corresponding to the received speech input. For example, when the intelligent server 200 is capable of calculating the result corresponding to the received speech input, the client module 151 may receive the result corresponding to the received speech input. The client module 151 may display the received result on the display 140.

The client module 151 according to an embodiment may receive a plan corresponding to the received speech input. The client module 151 may display results of executing a plurality of operations of the app according to the plan on the display 140. For example, the client module 151 may sequentially display the execution results of the plurality of operations on the display 140. In another example, the UE 100 may display only some of the execution results of the plurality of operations (for example, only the result of the last operation) on the display 140.

According to an embodiment, the client module 151 may receive, from the intelligent server 200, a request for information required to calculate the result corresponding to the speech input. According to an embodiment, the client module 151 may transmit the required information to the intelligent server 200 in response to the request.

The client module 151 according to an embodiment may transmit information about the results of performing the plurality of operations according to the plan to the intelligent server 200. The intelligent server 200 may identify that the received speech input has been correctly processed by using the result information.

The client module 151 according to an embodiment may include a speech recognition module. According to an embodiment, the client module 151 may recognize a speech input that executes a limited function through the speech recognition module. For example, the client module 151 may execute an intelligent app for processing a speech input to perform an organic operation through a specified input (for example, wake up!).

The intelligent server 200 according to an embodiment may receive information related to a user speech input from the UE 100 through a communication network. According to an embodiment, the intelligent server 200 may convert data related to the received speech input into text data. According to an embodiment, the intelligent server 200 may generate a plan for performing a task corresponding to the user speech input based on the text data.

According to an embodiment, the plan may be generated by an artificial intelligence (AI) system. The AI system may be a rule-based system or a neural network-based system (for example, a system based on a feedforward neural network (FNN) or a recurrent neural network (RNN)). Alternatively, the AI system may be a combination of the above systems or any other AI system. According to an embodiment, the plan may be selected from a set of predefined plans or generated in real time in response to a user request. For example, the AI system may select at least one of a plurality of predefined plans.

The intelligent server 200 according to an embodiment may transmit a result of the generated plan to the UE 100 or may transmit the generated plan to the UE 100. According to an embodiment, the UE 100 may display the result of the plan on the display 140. According to an embodiment, the UE 100 may display a result of performing an operation according to the plan on the display 140.

The intelligent server 200 according to an embodiment may include a front end 210, a natural language platform 220, a capsule database (DB) 230, an execution engine 240, an end user interface 250, a management platform 260, a big data platform 270, or an analytic platform 280.

The front end 210 according to an embodiment may receive a speech input from the UE 100. The front end 210 may transmit a response to the speech input.

According to an embodiment, the natural language platform 220 may include an automatic speech recognition (ASR) module 221, a natural language understanding (NLU) module 223, a planner module 225, a natural language generator (NLG) module 227, or a text-to-speech (TTS) module 229.

The ASR module 221 according to an embodiment may convert a speech input received from the UE 100 into text data. The NLU module 223 according to an embodiment may understand a user's intent by using the text data of the speech input. For example, the NLU module 223 may understand the user's intent by performing syntactic analysis or semantic analysis. The NLU module 223 according to an embodiment may understand the meaning of a word extracted from the speech input by using the linguistic features (for example, grammatical elements) of a morpheme or a phrase and match the understood meaning of the word to an intent, thereby determining the user's intent.

The planner module 225 according to an embodiment may generate a plan by using the intent determined by the NLU module 223 and parameters. According to an embodiment, the planner module 225 may determine a plurality of domains required to perform a task based on the determined intent. The planner module 225 may determine a plurality of operations included in each of the plurality of domains determined based on the intent. According to an embodiment, the planner module 225 may determine parameters required for performing the determined plurality of operations or result values output as a result of the execution of the plurality of operations. The parameters and the result values may be defined as concepts in specified formats (or classes). Accordingly, the plan may include the plurality of operations determined based on the user's intent and the plurality of concepts. The planner module 225 may determine relationships between the plurality of operations and the plurality of concepts in a stepwise (or hierarchical) manner. For example, the planner module 225 may determine an execution order of the plurality of operations determined based on the user's intent according to the plurality of concepts. In other words, the planner module 225 may determine the execution order of the plurality of operations based on the parameters required for the execution of the plurality of operations and the results output as a result of the execution of the plurality of operations. Accordingly, the planner module 225 may generate a plan including information about association (for example, ontology) between the plurality of operations and the plurality of concepts. The planner module 225 may generate the plan by using information stored in the capsule DB 230 that stores information about a set of relationships between concepts and operations.

The NLG module 227 according to an embodiment may convert specified information into text. The information converted into the text may be in the form of a natural language speech. The TTS module 229 according to an embodiment may convert information in the form of text into information in the form of a speech.

According to an embodiment, some or all of the functions of the natural language platform 220 may also be implemented in the UE 100.

The capsule DB 230 may store information about the relationships between the plurality of concepts and the plurality of operations corresponding to the plurality of domains. A capsule according to an embodiment may include a plurality of action objects (or action information) and concept objects (or concept information) included in the plan. According to an embodiment, the capsule DB 230 may store a plurality of capsules in the form of a concept action network (CAN). According to an embodiment, the plurality of capsules may be stored in a function registry included in the capsule DB 230.

The capsule DB 230 may include a strategy registry storing strategy information required for determining a plan corresponding to a speech input. In the presence of a plurality of plans corresponding to the speech input, the strategy information may include reference information for determining one plan. According to an embodiment, the capsule DB 230 may include a follow-up registry storing information about a follow-up operation to suggest the follow-up operation to the user in a specified situation. The follow-up operation may include, for example, a follow-up utterance. According to an embodiment, the capsule DB 230 may include a layout registry storing information about the layout of information output through the UE 100. According to an embodiment, the capsule DB 230 may include a vocabulary registry storing vocabulary information included in capsule information. According to an embodiment, the capsule DB 230 may include a dialog registry storing information about a dialog (or interaction) with the user. The capsule DB 230 may update the stored objects through a developer tool. The developer tool may include, for example, a function editor for updating action objects or concept objects. The developer tool may include a vocabulary editor for updating vocabularies. The developer tool may include a strategy editor for generating and registering a strategy for determining a plan. The developer tool may include a dialog editor that generates a dialog with the user. The developer tool may include a follow-up editor capable of activating a follow-up target and editing a follow-up speech that provides a hint. The follow-up target may be determined based on a currently set target, user preferences, or an environmental condition. In an embodiment, the capsule DB 230 may be implemented in the UE 100 as well.

The execution engine 240 according to an embodiment may calculate a result by using the generated plan. The end user interface 250 may transmit the calculated result to the UE 100. Accordingly, the UE 100 may receive the result and provide the received result to the user. The management platform 260 according to an embodiment may manage information used in the intelligent server 200. The big data platform 270 according to an embodiment may collect user data. The analytic platform 280 according to an embodiment may manage the quality of service (QoS) of the intelligent server 200. For example, the analytic platform 280 may manage components and a processing speed (or efficiency) of the intelligent server 200.

The service server 300 according to an embodiment may provide a specified service (for example, a food order or hotel reservation) to the UE 100. According to an embodiment, the service server 300 may be a server operated by a third party. The service server 300 according to an embodiment may provide information for generating a plan corresponding to a received speech input to the intelligent server 200. The provided information may be stored in the capsule DB 230. Further, the service server 300 may provide result information according to the plan to the intelligent server 200.

In the integrated intelligence system 10 described above, the UE 100 may provide various intelligent services to the user in response to a user input. The user input may include, for example, an input applied through a physical button, a touch input, or a speech input.

In an embodiment, the UE 100 may provide a speech recognition service through an intelligent app (or speech recognition app) stored therein. In this case, for example, the UE 100 may recognize a user utterance or a speech input received through the microphone and provide a service corresponding to the recognized speech input to the user.

In an embodiment, the UE 100 may perform a specified operation alone or in conjunction with the intelligent server and/or the service server, based on the received speech input. For example, the UE 100 may execute an app corresponding to the received speech input and perform the specified operation through the executed app.

In an embodiment, when the UE 100 provides the service in conjunction with the intelligent server 200 and/or the service server 300, the UE 100 may detect a user utterance through the microphone 120 and generate a signal (or speech data) corresponding to the detected user utterance. The UE 100 may transmit the speech data to the intelligent server 200 through the communication interface 110.

The intelligent server 200 according to an embodiment may generate a plan for performing a task corresponding to the speech input or the result of performing an operation according to the plan, in response to the speech input received from the UE 100. The plan may include, for example, a plurality of operations for performing a task corresponding to the user speech input, and a plurality of concepts related to the plurality of operations. The concepts may define parameters input for execution of the plurality of operations or result values output as a result of the execution of the plurality of operations. The plan may include information about association between the plurality of operations and the plurality of concepts.

The UE 100 according to an embodiment may receive the response through the communication interface 110. The UE 100 may output a speech signal generated inside the UE 100 to the outside through the speaker 130, or may externally output an image generated inside the UE 100 on the display 140.

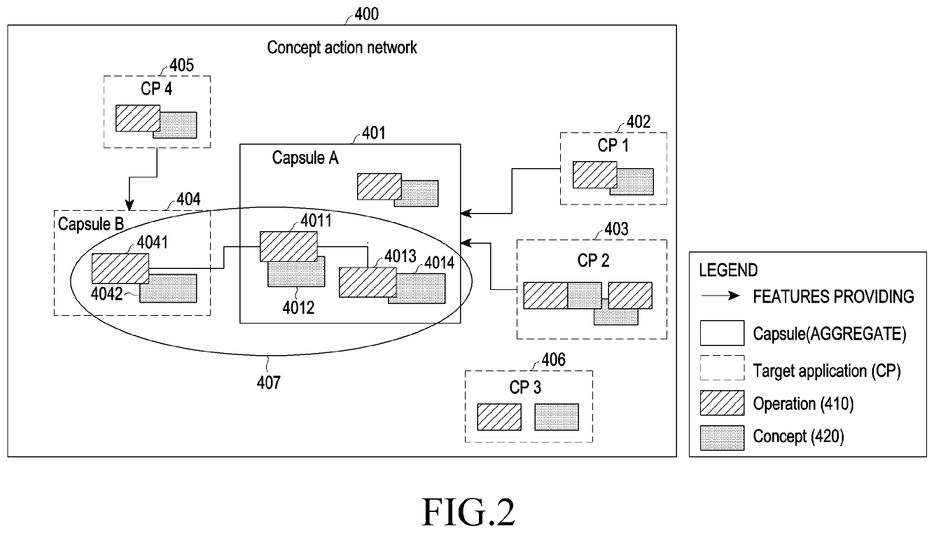

FIG. 2 is a diagram illustrating storage of information about association between concepts and operations in a DB according to various embodiments.

A capsule DB (for example, the capsule DB 230) of the intelligent server 200 may store capsules in the form of a CAN 400. The capsule DB may store an operation for processing a task corresponding to a user speech input and a parameter required for the operation, in the form of the CAN 400.

The capsule DB may store a plurality of capsules (capsule A 401 and capsule B 404) corresponding to a plurality of domains (for example, applications), respectively. According to an embodiment, one capsule (for example, capsule A 401) may correspond to one domain (for example, a location (geo) application). In addition, at least one service provider (for example, CP 1 402, CP 2 403, CP 3 406, or CP 4 405) for executing a function for a domain related to one capsule may correspond to the capsule. According to an embodiment, one capsule may include at least one operation 410 and at least one concept 420 to execute a specified function.

The natural language platform 220 may generate a plan for performing a task corresponding to a received speech input by using a capsule stored in the capsule DB. For example, the planner module 225 of the natural language platform 220 may generate a plan by using a capsule stored in the capsule DB. For example, a plan 407 may be generated by using operations 4011 and 4013 and concepts 4012 and 4014 of capsule A 410 and an operation 4041 and a concept 4042 of capsule B 404.

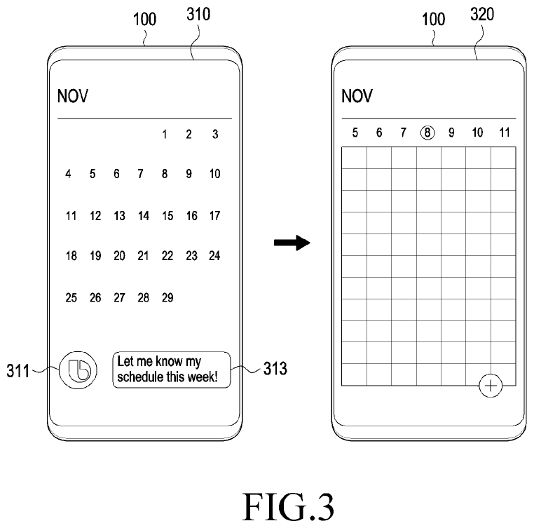

FIG. 3 is a diagram illustrating a screen on which a UE processes a received speech input through an intelligent app according to various embodiments.

The UE 100 may execute an intelligent app to process a user input through the intelligent server 200.

According to an embodiment, when the UE 100 recognizes a specified speech input (for example, wake up!) or receives an input through a hardware key (for example, a dedicated hardware key) on a screen 310, the UE 100 may execute an intelligent app to process the speech input. The UE 100 may, for example, execute the intelligent app while running a scheduling app. According to an embodiment, the UE 100 may display an object (for example, an icon) 311 representing the intelligent app on the display 140. According to an embodiment, the UE 100 may receive a speech input by a user utterance. For example, the UE 100 may receive a speech input “Tell me about this week's schedule!”. According to an embodiment, the UE 100 may display a user interface (UI) 313 (for example, an input window) of the intelligent app, on which text data of the received speech input is displayed on the display.

According to an embodiment, on a screen 320, the UE 100 may display a result corresponding to the received speech input on the display. For example, the UE 100 may receive a plan corresponding to the received user input and display “this week's schedule” on the display according to the plan.

An intelligence system according to various embodiments will be described below. The term, utterance may correspond to speech described above.

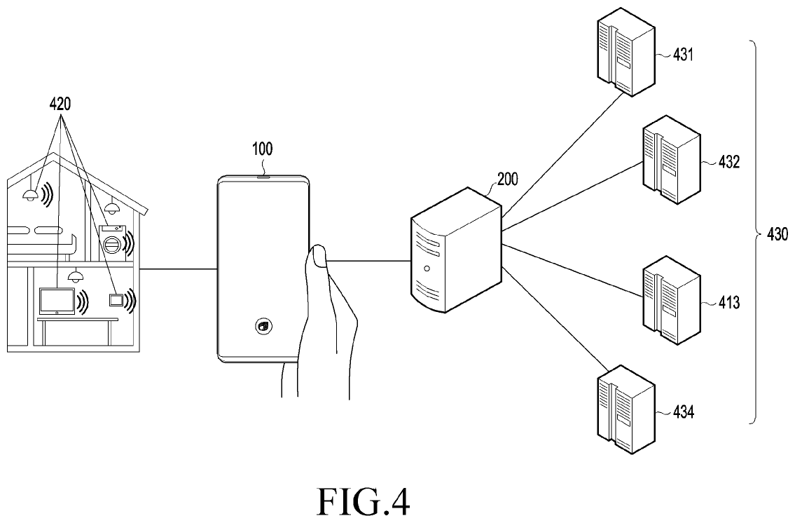

FIG. 4 is a diagram illustrating an exemplary configuration of an intelligence system according to various embodiments.

According to various embodiments, the intelligence system may include an electronic device, an intelligent server, and an external electronic device, as illustrated in FIG. 4.

The electronic device 100 will be described below. A description of the electronic device 100 redundant to that of FIG. 1 will be avoided.

According to various embodiments, the electronic device 100 may obtain various pieces of information to provide a speech recognition service. The electronic device 100 may execute an intelligent app (for example, Bixby) based on a user input (for example, a speech input that calls the intelligent app). The electronic device 100 may receive an utterance from a user (a user utterance) during execution of the intelligent app. Further, the electronic device 100 may obtain various pieces of additional information during execution of the intelligent app. The various pieces of additional information may include context information and/or user information. For example, the context information may include information about an application or program running in the electronic device 100, information about a current location, and so on. For example, the user information may include information about a use pattern (for example, an application use pattern) of the electronic device 100, personal information (for example, age) about the user, and so on.

According to various embodiments, the electronic device 100 may transmit information about the received user utterance to the intelligent server 200. The information about the user utterance refers to various types of information representing the received user utterance, and may include information of a speech signal type in which the user utterance is not processed, or text-type information in which the received user utterance is processed to corresponding text (for example, the user utterance is processed by ASR). The electronic device 100 may also provide the obtained additional information to the intelligent server 200.

According to various embodiments, the electronic device 100 may receive processing result information from the intelligent server 200 in response to the processing result of the user utterance at the intelligent server 200, and provide a service to the user based on the processing result information. For example, the electronic device 100 may display content corresponding to the user utterance on the display based on the received processing result information (for example, UI/UX including content corresponding to the user utterance). For example, the electronic device 100 may further provide a service that provides an operation of an application corresponding to the user utterance on the electronic device based on the processing result information (for example, a deep link for executing the application corresponding to the user utterance). For example, the electronic device 100 may further provide a service of controlling at least one external electronic device 440 based on the processing result information.

The at least one external electronic device 440 will be described below.

According to various embodiments, the at least one external electronic device 440 may be a target device connected to the electronic device 100 for communication based on various types of communication schemes (for example, WiFi and so on) and controlled by a control signal received from the electronic device 100. In other words, the external electronic device 440 may be controlled by the electronic device 100 based on specific information obtained by the user utterance. The external electronic device 440 may be an Internet of things (IoT) device managed together with the electronic device 100 in a specific cloud (for example, a smart home cloud).

Now, the intelligent server 200 will be described. A description of the intelligent server 200 redundant to that of FIG. 1 will be avoided.

According to various embodiments, the intelligent server 200 may process a user utterance received from the electronic device 100 to obtain information for providing a service corresponding to the user utterance. The intelligent server 200 may refer to additional information received along with the user utterance from the electronic device 100 to process the user utterance.

According to various embodiments, the intelligent server 200 may cause a voice assistant to process the user utterance. For example, the intelligent server 200 may allow a voice assistant provided in the intelligent server 200 to process the user utterance and obtain processing result information from the voice assistant, or may cause an external server linked to the intelligent server 200 to process the user utterance and thus obtain processing result information from the external server. Since the voice assistant may perform the same operation as the afore-described capsule DB, a redundant description will not be provided. Since the processing result information obtained from processing the utterance by the voice assistant may be a plan for performing the above-described task or a result of performing an operation according to the plan, a redundant description will be avoided. Further, the processing result information may further include at least one of a deep link including an access mechanism for accessing a specific screen of a specified application or visual information (UI/UX) for providing a service.

According to various embodiments, the intelligent server 200 may obtain a voice assistant for processing a user utterance from a developer server 430. For example, the intelligent server 200 may obtain a capsule for processing the user utterance from the developer server 430. For example, a developer of the developer server 430 may register voice assistants to the intelligent server 200. When the developer server 430 is connected to the intelligent server 200, the intelligent server 200 may cause a UI for registering the voice assistants to be displayed on the developer server 430, and the developer may register the voice assistants on the displayed UI. The intelligent server 200 may store its autonomously generated voice assistants, not limited to the above description.

According to various embodiments, a voice assistant may be assigned to at least one category. For example, the developer server may select a category to which the voice assistant is to be registered. For example, when the developer server accesses the intelligent server to register the voice assistant, the developer server may receive information about a plurality of categories available for registration of the voice assistant and display the information about the plurality of categories on an interface. The developer server may receive a choice of a specific one of the plurality of displayed categories from the developer and transmit information about the selected specific category to the intelligent server. The intelligent server may store the voice assistant in the specific category based on the received information. In a specific example, according to the above registration, a first category “Delivery Service” may include a “first voice assistant” and a “second voice assistant”, and a category “Cafes” may include the “first voice assistant” and a “third voice assistant”. An operation of registering a voice assistant will be described later in conjunction with an operation of the intelligent server described later.

According to various embodiments, the intelligent server may manage utterances of voice assistants registered to categories, which will be described later in detail.

The developer server 430 will be described below.

According to various embodiments, each of a plurality of developer servers 431, 432, 433, and 434 may register a voice assistant for processing user utterances in the intelligent server 200. For example, the developer server 430 (or capsule developer) may produce a voice assistant for processing user utterances and register the voice assistant to the intelligent server 200. While the registration procedure may be performed by directly accessing the intelligent server 200 and registering the voice assistant to the connected intelligent server 200 by the developer server 430, which should not be construed as limiting, a registration server may be provided separately, register the voice assistant, and provide the registered voice assistant to the intelligent server 200.

According to various embodiments, at least one function provided by capsules generated by the plurality of developer servers 411, 412, 413, and 414 may be different from each other or may be similar. For example, a first voice assistant generated by a first developer server may provide a first function (for example, a music-related function), a second voice assistant generated by a second developer server may provide a second function (for example, a music-related function), . . . , an N^{th} voice assistant generated by an N^{th} developer server may provide an N^{th} function (for example, a video-related function). As such, various services corresponding to user utterances may be provided to the user based on various services available from each voice assistant.

An example of the configuration of the intelligent server 200 will be described below.

According to various embodiments, the intelligent server 200 may include a plurality of modules, as described later. The plurality of modules may be programs, computer code, or instructions that are coded so that the specific intelligent server 200 performs specified operations. That is, the intelligent server 200 may store the plurality of modules in a memory, and the plurality of modules included in the memory may cause a processor to perform the specified operations. The description of the plurality of modules included in the above-described intelligent server 200 may also be applied to a description of modules included in the electronic device 100 and the developer server 430.

According to various embodiments, a processor of each of the electronic device 100, the intelligent server 200, and the developer server 430 may be configured to control at least one component of the electronic device 100, the intelligent server 200, or the developer server 430 to perform an operation described below. Alternatively, without being limited to the above description, a computer code or instructions stored in a memory of each of the electronic device 100, the intelligent server 200, and the developer server 430 may cause the processor (not shown) of the electronic device 100, the intelligent server 200, or the developer server 430 to perform operations described below. The following description of a memory 2030 and a processor 2020 is also applied to the processor and memory of each of the electronic device 100, the intelligent server 200, and the developer server 430. Accordingly, a redundant description will be avoided.

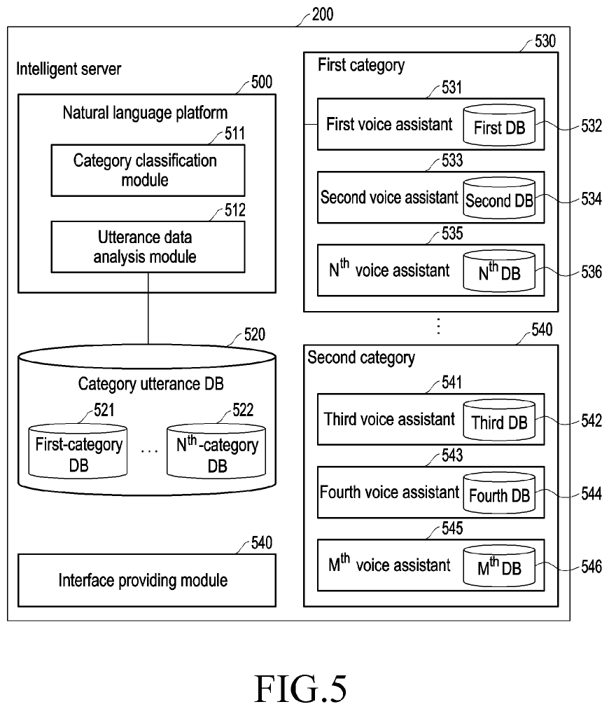

FIG. 5 is a diagram illustrating an example of the configuration of the intelligent server 200 according to various embodiments.

According to various embodiments, the intelligent server 200 may include a natural language platform 510 including a category classification module 511 and an utterance data analysis module 512, a category utterance DB 520 including a plurality of category DBs 521 and 522, a plurality of voice assistants 531, 533, 535, 541, 543, and 545 included in a plurality of categories 530 and 540, and an interface providing module 550.

The natural language platform 510, and the category classification module 511 and the utterance data analysis module 512 included in the natural language platform 510 will be described below.

According to various embodiments, like the natural language platform 510 illustrated in FIG. 1, the natural language platform 510 may include an automatic speech recognition (ASR) module (not shown), an NLU module (not shown), a planner module (not shown), an NLG module (not shown), or a TTS module (not shown). A redundant description of each module which is not shown will be avoided herein.

According to various embodiments, the natural language platform 510 may identify categories (for example, the categories 530 and 540) corresponding to utterances by analyzing the utterances and provide information about the identified categories (for example, the categories 530 and 540), or may train voice assistants (for example, the voice assistants 531, 533, 535, 541, 543, and 545) related to specific categories with utterances by analyzing the utterances. For example, the natural language platform 510 may identify the intent of an utterance by analyzing the utterance, identify a category corresponding to the utterance based on the identified intent, and generate information related to the identified category. For example, the natural language platform 510 may analyze a plurality of utterances related to a plurality of voice assistants and train the plurality of voice assistants with a specific utterance.

According to various embodiments, the category classification module 511 may analyze an utterance and identify a category (for example, the category 530 or 540) corresponding to the utterance based on the result of the analysis. For example, based on an intent obtained by analyzing an utterance in the NLU module, the category classification module 511 may select a category supporting the intent.

According to various embodiments, the utterance data analysis module 512 may analyze utterances associated with voice assistants (for example, the voice assistants 531, 533, 535, 541, 543, and 545) registered to the intelligent server 200, and train the voice assistants (for example, the voice assistants 531, 533, 535, 541, 543, and 545) with a specific utterance based on the result of the analysis. For example, the utterance data analysis module 512 may analyze utterances associated with voice assistants included in a specific category, and train the voice assistants of the specific category with a specific one of the analyzed utterances.

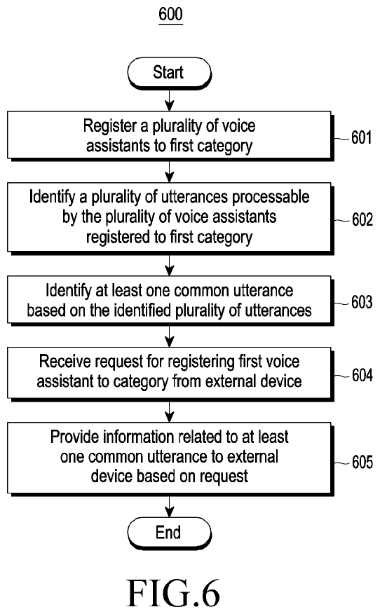

According to various embodiments, the specific utterance with which the voice assistants are to be trained may be an utterance commonly supported by the specific category (a common utterance to be described later). For example, the specific utterance may refer to an utterance having the same trait as a common utterance. The same trait may mean that information about utterances is identical and/or similar to each other (for example, a similarity within a preset range). For example, the same trait may mean that the analysis results (for example, intents and/or parameters) of utterances in various modules (for example, the NLU module 223) that may be implemented in the natural language platform 220 are identical and/or similar to each other. For example, when a specific category commonly supports an utterance “Get coffee delivered”, specific utterances for training may be “Get coffee delivered”, “Order coffee”, and so on, which are utterances having the same and/or similar intent and/or parameters as and/or to the common utterance, “Get coffee delivered”. An operation of training voice assistants of a specific category with a specific utterance will be described later in detail with reference to FIGS. 6 to 12.

The category utterance DB 520 will be described below.

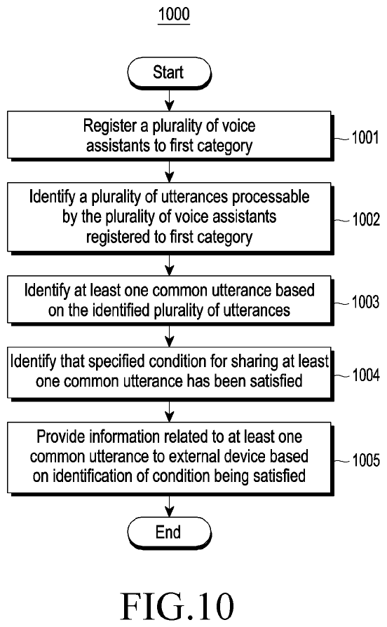

According to various embodiments, the category utterance DB 520 may store information about supported utterances in the plurality of categories 530 and 540 (for example, information resulting from analyzing the utterances in various modules included in the natural language understanding platform 220). A supported utterance may refer to an utterance processable by at least one voice assistant of a corresponding category. For example, when the first voice assistant 531 and the second voice assistant 533 of the first category 530 are capable of processing a first utterance (for example, “Get coffee delivered”), the category utterance DB 520 may store the first utterance as supported by the first category 530. For example, even when the first voice assistant 531 and the second voice assistant 533 of the first category 530 are capable of processing the first utterance, but the N^{th} voice assistant 535 of the first category 530 is not capable of supporting the first utterance, the category utterance DB 520 may store the first utterance as supported by the first category 530. In this case, the intelligent server 200 may transmit the first utterance to the N^{th} voice assistant 535 and train the N^{th} voice assistant 535 so that the N^{th} voice assistant 535 may process the first utterance. The training operation will be described later in detail with reference to FIGS. 10, 11 and 12.

Now, a description will be given of a voice assistant (for example, the voice assistant 531, 533, 535, 541, 543, or 545). Since the description of the capsule DB 230 may be applied to the voice assistant, a redundant description will not be provided herein.

According to various embodiments, a plurality of voice assistants (for example, the voice assistants 531, 533, 535, 541, 543, and 545) may process utterances and generate processing result information to provide services corresponding to the utterances. In other words, each of the plurality of voice assistants (for example, the voice assistants 531, 533, 535, 541, 543, and 545) may store (not shown) processing result information corresponding to a specific utterance, and upon receipt of information about the specific utterance, identify and provide the processing result information.

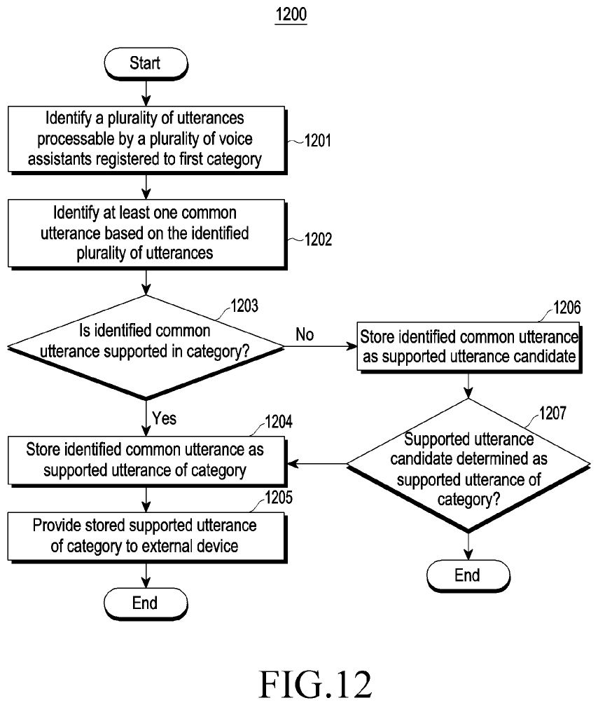

According to various embodiments, the plurality of assistants 531, 533, 535, 541, 543, and 545 may store their related utterance DBs (e.g., DBs storing information about utterances processable by the voice assistants) 532, 534, 536, 642, 544, and 546. A DB related to a voice assistant will be described later in detail with reference to FIGS. 12, 13 and 14. The DBs 532, 534, 536, 542, 544, and 546 related to the voice assistants may be stored separately from the voice assistants, not limited to FIG. 5.

According to various embodiments, each of the plurality of voice assistants 531, 533, 535, 541, 543 and 545 may be included in at least one of the category 530 or the category 540. For example, the plurality of voice assistants 531, 533, 535, 541, 543, and 545 may be included in the at least one of the category 530 or the category 540 based on a request for registering the plurality of voice assistants 531, 533, 535, 541, 543, and 545 to the at least one of the category 530 or the category 540. For example, when the developer server 430 requests registration of a voice assistant to the intelligent server 200, the developer server 430 may receive information related to a plurality of categories (for example, the categories 530 and 540) available for registration of the specific voice assistant. The developer server 430 may request registration of the specific voice assistant to one of the plurality of categories (for example, the categories 530 and 540). The intelligent server 200 may include and manage the specific voice assistant in the category based on the request for registration of the specific voice assistant to the category. The plurality of voice assistants 531, 533, 535, 541, 543, and 545 may be classified according to the categories 530 and 540 to which the plurality of voice assistants have been registered. For example, the voice assistants 531, 533, and 535 of the first category 530 may be associated with each other, and the voice assistants 541, 543, and 545 of the second category 540 may be associated with each other. On the other hand, the voice assistants 531, 533, and 535 of the first category 530 may have no relation to the voice assistants 541, 543, and 545 of the second category 540. The first voice assistant 531 may not be limited to the first category 530 but can be further included in a category other than the first category 530.

The interface providing module 550 will be described below.

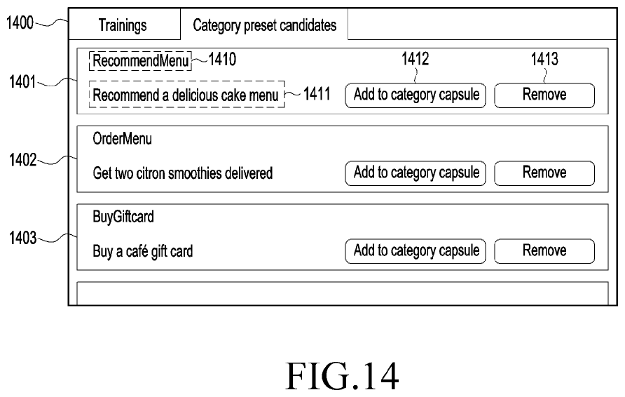

According to various embodiments, the interface providing module 550 may provide information such that an interface for providing a service is displayed on an external device connected to the intelligent server 200. For example, when the developer server 430 accesses the intelligent server 200, the interface providing module 550 may provide an interface for registering a voice assistant to the developer server 430. The interface providing operation will be described later in detail with reference to FIGS. 14, 15, 16, and 17.

The above-described modules of the intelligent server 200 are not limited to the above description, and may be implemented in an external device (for example, the electronic device 100) other than the intelligent server 200. For example, the natural language platform 510 illustrated in FIG. 5 may be included in the electronic device 100, while the remaining modules may be included in the intelligent server 200. Accordingly, the electronic device 100 may perform an operation based on the natural language platform 510, and the intelligent server 200 may perform an operation by the remaining modules.

For convenience of description, the modules of the intelligent server 200 will be described as included in the intelligent server 200. However, the modules of the intelligent server 200 may be implemented in an external device (for example, the electronic device 100), not limited to the intelligent server 200, and thus the operation of the intelligent server 200 according to various embodiments described below may also be performed in the electronic device 100.

An example of the operation of the intelligent server 200 according to various embodiments will be described. A redundant description to the forgoing description of the intelligent server 200 will be avoided herein.

According to various embodiments, the intelligent server 200 may enable a voice assistant newly registered to a specific category to process a specific utterance related to a plurality of assistants included in the specific category.

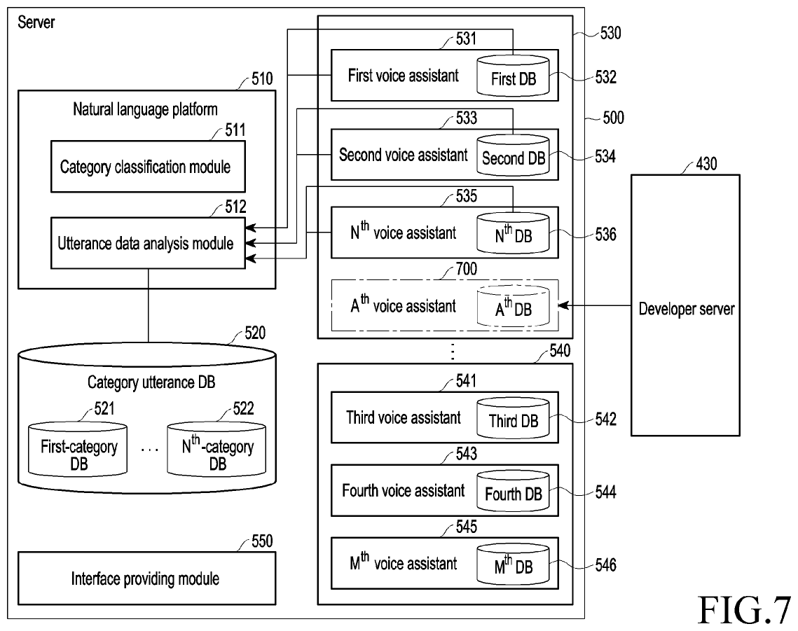

FIG. 6 is a flowchart 600 illustrating an exemplary operation of the intelligent server 200 according to various embodiments. According to various embodiments, the operation of the intelligent server 200 may be performed in a different order, not limited to the order illustrated in FIG. 6. According to various embodiments, more operations than the operations of the intelligent server 200 illustrated in FIG. 6 may be performed or at least one operation fewer than the operations of the intelligent server 200 illustrated in FIG. 6 may be performed. FIG. 6 will be described with reference to FIGS. 7, 8, and 9.

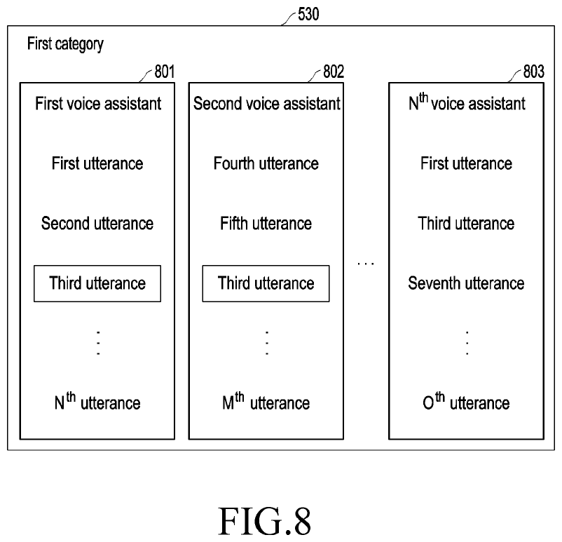

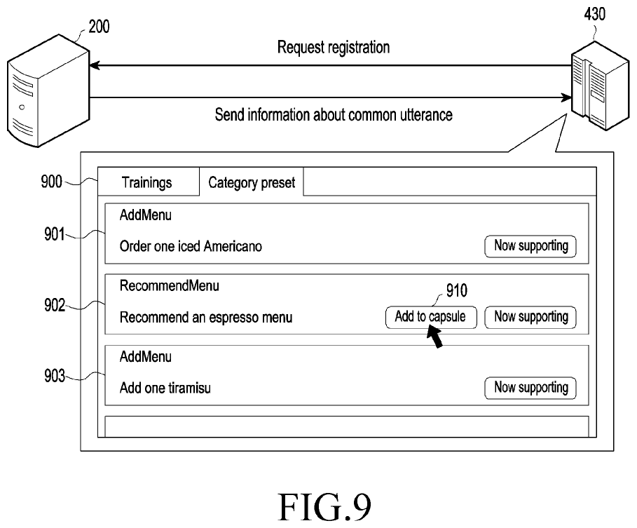

FIG. 7 is a diagram illustrating an exemplary operation of identifying at least one common utterance by the utterance data analysis module 512 in the intelligent server 200 according to various embodiments. FIG. 8 is a diagram illustrating an example of utterances processable by a plurality of voice assistants included in a specific category according to various embodiments. FIG. 9 is a diagram illustrating an exemplary operation of receiving a request for registration of a specific voice assistant to a specific category from another device by the intelligent server 200 according to various embodiments.

According to various embodiments, the intelligent server 200 (for example, the processor of the intelligent server 200) may register a plurality of voice assistants to the first category 530 in operation 601. For example, the intelligent server 200 may receive a request for registering a voice assistant from at least one developer server 430 connected to the intelligent server 200. The intelligent server 200 may provide information about a plurality of categories (for example, the categories 530 and 540 in FIG. 7) available for registration of the voice assistant to the at least one developer server 430, based on the received registration request. The at least one developer server 430 may display an interface including the plurality of categories based on the information about the plurality of categories (for example, the categories 530 and 540). When a developer (or user) selects at least one of the plurality of categories (for example, the categories 530 and 540) available for registration of the voice assistant through the at least one developer server 430, the intelligent server 200 may receive information about the selected at least one category from the at least one developer server 430. The intelligent server 200 may register the requested voice assistant to the selected at least one category based on the information about the selected at least one category. In other words, the intelligent server 200 may manage (or store) voice assistants requested for registration (for example, the voice assistants 531, 533, 535, 541, 543, and 545) to the at least one category (for example, the categories 530 and 540), as illustrated in FIG. 7. The intelligent server 200 may register, to the at least one category, the utterance DBs related to the voice assistants (for example, utterance DBs processable by the voice assistants (later-described training DBs related to the voice assistants) 532, 534, 536, 542, 544, and 546 and DBs (not shown) storing processing result information corresponding to the utterances, together with the voice assistant requested for registration. Alternatively, the utterance DBs 532, 534, 536, 542, 544, and 546 processable by the voice assistants may be obtained from the developer server 430 separately from the voice assistants to be registered, or the intelligent server 200 may identify utterances processable by the registered voice assistants to obtain the utterance DBs 532, 534, 536, 542, 544, and 546.

According to various embodiments, the intelligent server 200 (for example, the processor of the intelligent server that performs an operation based on the utterance data analysis module 512) may identify a plurality of utterances processable by a plurality of voice assistants registered to a first category in operation 602. For example, the intelligent server 200 (for example, the utterance data analysis module 512) may identify information about utterances processable by each of the plurality of voice assistants 531, 533, and 535 included in the first category 530, as illustrated in FIG. 7. For example, the intelligent server 200 (for example, the utterance data analysis module 512) may identify information about the utterances processable by the plurality of voice assistants 531, 533, and 535 included in the first category 530 from the utterance DBs 532, 534, and 536 for the plurality of voice assistants 531, 533, and 535 included in the first category 530, as illustrated in FIG. 7.

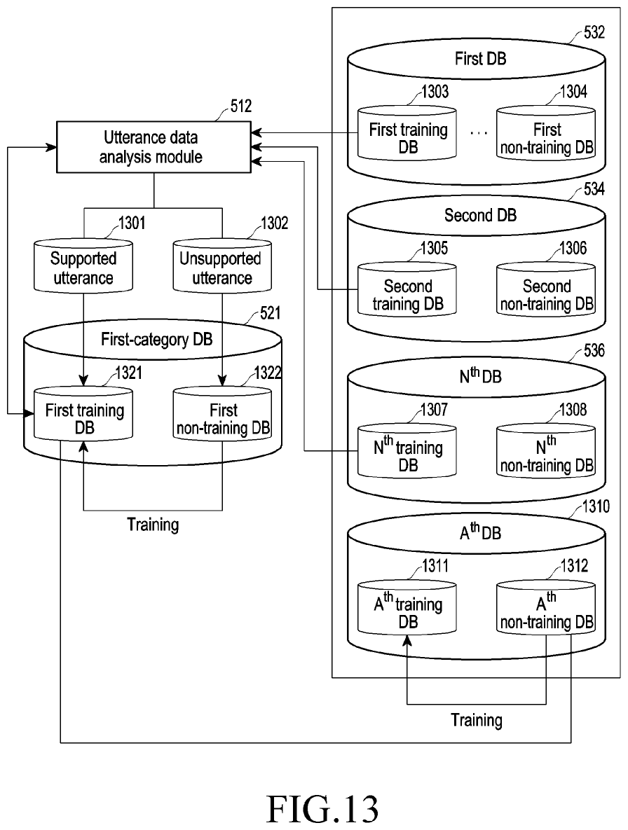

According to various embodiments, the intelligent server 200 (for example, the processor of the intelligent server that performs an operation based on the utterance data analysis module 512) may identify at least one common utterance based on the plurality of obtained utterances in operation 603. For example, when identifying at least one common utterance, the intelligent server 200 may store information about the at least one identified common utterance in the first-category utterance data DB. The intelligent server 200 may further identify whether the identified at least one common utterance is supported by the first category 530 and store information about the at least one common utterance as supported by the first category 530 in the first-category DB 521 depending on whether the at least one common utterance is supported by the first category 530, which will be described later in detail with reference to FIGS. 12 and 13.

According to various embodiments, the intelligent server 200 (for example, the processor of the intelligent server that performs an operation based on the utterance data analysis module 512) may identify at least one utterance satisfying a specified similarity-related condition as a common utterance among the utterances processable by the plurality of identified voice assistants 531, 533, and 535 of the first category 530.

For example, the intelligent server 200 (for example, the processor of the intelligent server that performs an operation based on the utterance data analysis module 512) may identify the same utterances among utterances 801, 802, and 803 processable by the plurality of identified voice assistants 531, 533, and 535 of the first category 530 as a common utterance, as illustrated in FIG. 8. While the intelligent server 200 may identify, as a common utterance, the same utterances (for example, a third utterance) among the utterances 801, 802, and 803 processable by all of the plurality of voice assistants included in the first category 530, this should not be construed as limiting. The intelligent server 200 may identify, as a common utterance, the same utterances among utterances (for example, the utterances 801 and 802) processable by at least a part (for example, at least two) of the plurality of voice assistants included in the first category, as illustrated in FIG. 8.

For example, the intelligent server 200 (for example, the processor of the intelligent server that performs an operation based on the utterance data analysis module 512) may identify, as a common utterance, utterances corresponding to each other among the utterances 801, 802, and 803 processable by the plurality of identified voice assistants included in the first category 530, based on information about the utterances 801, 802, and 803. For example, the intelligent server 200 may identify, as a common utterance, utterances having a similarity greater than or equal to a threshold among the processable utterances. For example, the intelligent server 200 may identify, as a common utterance, an utterance processable by the first voice assistant 531 of the first category 530, “Get pizza delivered”, an utterance processable by the second voice assistant 533 of the first category 530, “I want to have pizza”, and an utterance processable by the N^{th} voice assistant 535 of the first category 530, “Tell me a pizza store in the neighborhood”, because the utterances are not the same but have similarities equal to or greater than a threshold. The intelligent server 200 may compare patterns of the information about the processable utterances based on the information about the processable utterances, and identify similarities among the processable utterances based on the result of the pattern comparison. The intelligent server 200 may identify utterances having similarities equal to or greater than the threshold as a common utterance. The comparison between the patterns of the information about the utterances may amount to comparing the patterns of the intents of the utterances or comparing the patterns of text corresponding to the utterances, which should not be construed as limiting. Various analysis operations for comparing the similarities of utterances may be performed.

According to various embodiments, the intelligent server 200 (for example, the processor of the intelligent server) may receive a request for registration of a first voice assistant to the category from an external device in operation 604. For example, as illustrated in FIG. 7, the intelligent server 200 may receive a request for registering the first voice assistant from a first developer server. As in operation 601, the intelligent server 200 may receive a request for registration of an A^{th} voice assistant 700 to the first category 530 from the first developer server. In other words, the intelligent server 200 may receive a request for newly registering the A^{th} voice assistant 700 from the first developer server and identify that the new A^{th} voice assistant 700 is included in the first category 530.

According to various embodiments, the intelligent server 200 (for example, the processor of the intelligent server) may provide information about the at least one common utterance to the external device based on the request in operation 605. For example, based on the reception of the request for registration of the A^{th} voice assistant 700 to the first category 530 from the developer server 430, the intelligent server 200 may include the A^{th} voice assistant 700 in the first category 530. As illustrated in FIG. 9, based on the identification that the voice assistant 700 has been newly included in the first category 530, the intelligent server 200 may provide information about the at least one common utterance (the third utterance illustrated in FIG. 8) to the developer server 430, so that the A^{th} voice assistant 700 may process the at least one common utterance (for example, the third utterance illustrated in FIG. 8). For example, as illustrated in FIG. 9, the developer server 430 may receive information about a common utterance “recommend an espresso menu” in a category “RecommendMenu” to which the first voice assistant is to be registered. The A^{th} voice assistant 700 may be trained to process the at least one common utterance based on the information about the at least one common utterance.

According to various embodiments, the training of the voice assistant with the common utterance may imply that the voice assistant is enabled to identify the common utterance and recognize utterances corresponding to the common utterance as processing targets. For example, the voice assistant trained with the common utterance may identify the results of analysis of the common utterance in various modules such as the NLU module and the ASR module which may be implemented in the natural language platform 220 as information about the common utterance, and identify utterances corresponding to the analyzed results as processing targets. For example, the voice assistant trained with the common utterance may recognize, as processing targets, utterances having intends and/or parameters identical to and/or similar to the intent of the common utterance and/or parameters.

According to various embodiments, the training of the voice assistant with the common speech may mean that the voice assistant is enabled to provide a processing result corresponding to the common utterance. For example, the intelligent server 200 or the developer server 430 may obtain information about the common utterance and processing result information corresponding to the common utterance to train the voice assistant, and train the voice assistant so that the voice assistant may return the obtained processing result information in response to the common utterance and utterances corresponding to the common utterance. The processing result information may be obtained from processing result information returned in response to the common utterance by the voice assistants of the specific category. Alternatively, the processing result information may be separately obtained by the developer of the voice assistant. Therefore, when the intelligent server 200 trains the voice assistant, the developer server 430 that registers the voice assistant may provide the processing result information to the intelligent server 200. When the developer server 430 trains the voice assistant, the developer may input the processing result information to the developer server 430.

According to various embodiments, the developer server 430 may display an interface 900 including at least one common utterance such as utterances 901, 902, and 903 illustrated in FIG. 9, based on received information about the at least one common utterance, and at least one graphic element (for example, a graphic element 910) used to determine whether to support the at least one common utterance. The developer server 430 may receive an input on the graphic element 910 for determining whether to support the at least one common utterance from the developer (or user) on the interface 900, and identify whether the A^{th} voice assistant 700 supports the at least one common utterance, based on the received input. When identifying that the at least one common utterance is supported, the developer server 430 may train the voice assistant to process the common utterance, or may request the intelligent server 200 to train the voice assistant so that the voice assistant may process the common utterance.

Without being limited to operation 605, the intelligent server 200 may train the newly included first voice assistant to process the at least one common utterance without providing the information about the at least one common utterance to the developer server 430. In other words, the intelligent server 200 may train the first voice assistant without feedback with the developer server 430.

According to the above-described operation, information about a common supported utterance is provided so that a voice assistant newly registered to a specific category may process the common utterance supported by the previously registered voice assistants of the specific category. Accordingly, the operational load of voice assistant training with an utterance may be alleviated.

Further, as a common utterance supported by the voice assistants of a specific category become processable by the above-described operation, the number of utterances which are not supported by each of the voice assistants may be reduced. The resulting increased possibility of processing user utterances by the voice assistants of the specific category may increase the efficiency of processing the user utterances.

Further, because training is performed based on information about an utterance obtained from a plurality of voice assistants included in a specific category in the above-described operation, the intelligent server 200 may have a reduced operational load of obtaining an utterance for training of a voice assistant.

Another example of the operation of the intelligent server 200 according to various embodiments will be described below. A redundant description to the above description of the intelligent server 200 will be avoided herein.

According to various embodiments, the intelligent server 200 may train at least one voice assistant included in a specific category with an utterance, based on identification that a specified condition is satisfied. In other words, the intelligent server 200 may train not only a voice assistant newly registered to the specific category as described above, but also a voice assistant included in the specific category based on satisfaction of the specified condition.

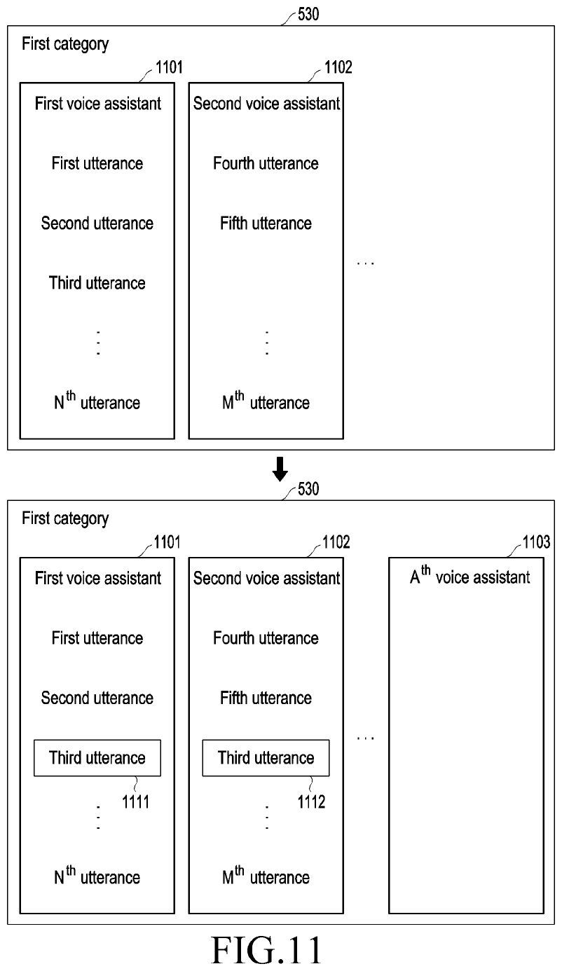

FIG. 10 is a flowchart 1000 illustrating an exemplary operation of the intelligent server 200 according to various embodiments. According to various embodiments, the operation of the intelligent server 200 may be performed in a different order, not limited to the order illustrated in FIG. 10. According to various embodiments, more operations than the operations of the intelligent server 200 illustrated in FIG. 10 may be performed or at least one operation fewer than the operations of the intelligent server 200 illustrated in FIG. 10 may be performed. FIG. 10 will be described with reference to FIG. 11.

FIG. 11 is a diagram illustrating an exemplary operation of identifying that a specified condition is satisfied in the intelligent server 200 according to various embodiments.

According to various embodiments, the intelligent server 200 may register a plurality of voice assistants to a first category in operation 1001, identify a plurality of utterances processable by the plurality of voice assistants registered in the first category in operation 1002, and identify at least one common utterance based on the plurality of obtained utterances in operation 1003. Since operations 1001, 1002, and 1003 of the intelligent server 200 may be performed in the same manner as operations 601, 602, and 603 of the intelligent server 200 described before, a redundant description will be avoided.

According to various embodiments, the intelligent server 200 may identify whether a condition for sharing at least one common utterance has been satisfied in operation 1004.

According to various embodiments, when a new voice assistant is included in a specific category as described above with reference to FIGS. 6, 7, 8, and 9, the intelligent server 200 may identify that the specified condition has been satisfied. For example, as illustrated in FIG. 11, when a specific voice assistant (for example, an A^{th} voice assistant 1103) is registered to a specific category (for example, the first category 530), the intelligent server 200 may identify that the specified condition has been satisfied.

According to various embodiments, when identifying a new common utterance in a specific category, the intelligent server 200 may identify that the specified condition has been satisfied.

For example, as illustrated in FIG. 11, as utterances (for example, third utterances 1111 and 1112) processable by a specific voice assistant (for example, a second voice assistant 1102) included in a specific category (for example, the first category 530) have been updated, the intelligent server 200 may identify a new common utterance in the specific category. For example, as illustrated in FIG. 11, the second voice assistant 1102 becomes capable of newly processing a specific utterance (for example, the third utterance 1112), the new common utterance of the specific category may be identified. When the third utterance 1111 has already been stored as an utterance processable by another voice assistant (e.g., the first voice assistant 1101) included in the specific category, the third utterances 1111 and 1112 may be identified as a common utterance because the second voice assistant 1102 becomes capable of processing the new specific utterance (for example, the third utterance 1112) and thus the third utterances 1111 and 1112 are identified as satisfying the specified similarity-related condition. Information about the specific utterance may be stored in a DB (for example, a training DB) related to the specific voice assistant (for example, the voice assistant 532, 534, or the like in FIG. 5), and the intelligent server 200 may compare the stored information about the specific utterance with information about utterances related to other voice assistants, stored in DBs. The intelligent server 200 may identify the specific utterance as a common utterance based on the comparison result. Since the operation of identifying a common utterance by the intelligent server 200 may be performed in the same manner as operation 603 of the intelligent server 200 described above, a redundant description will be avoided.

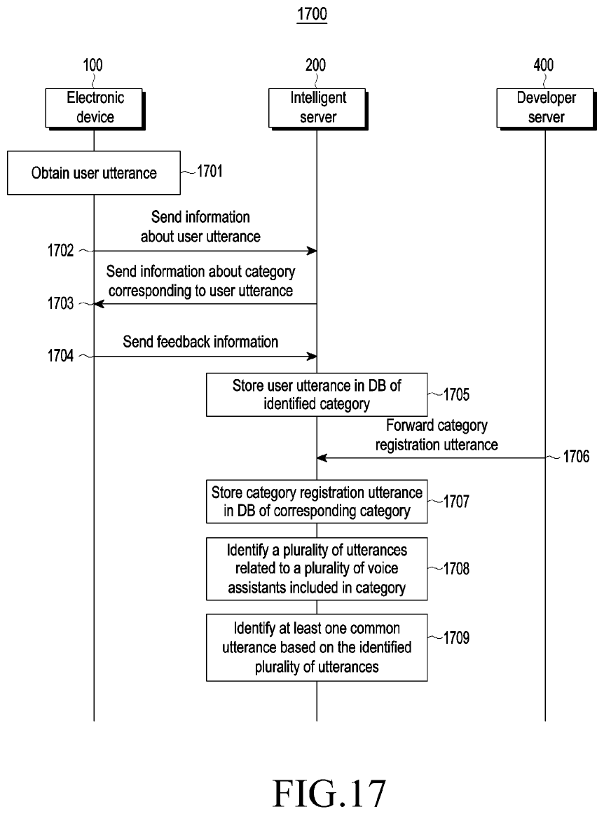

For example, the intelligent server 200 may receive information about a user utterance from the electronic device 100 and identify a new supported utterance of a specific category. The operation of receiving information about a user utterance and identifying a supported utterance by the intelligent server 200 will be described later in detail with reference to FIGS. 17, 18, and 19.

For example, the intelligent server 200 may receive information about a category registration utterance from the developer server 430 and thus identify a new supported utterance in a specific category. The operation of receiving information about a category registration utterance and identifying a supported utterance by the intelligent server 200 will be described later in detail with reference to FIGS. 17, 18, and 19.

According to various embodiments, the intelligent server 200 may identify whether a specified condition for sharing a common utterance is satisfied based on a request received from the developer server 430. For example, when the intelligent server 200 receives a request for a common utterance from the developer server 430 (or developer) that has registered a voice assistant to a specific category, the intelligent server 200 may identify that the specified condition has been satisfied.

According to various embodiments, the intelligent server 200 may provide information related to the common utterance to an external device based on identifying that the condition has been satisfied in operation 1005. Since operation 1005 of the intelligent server 200 may be performed in the same manner as operation 605 of the intelligent server 200 described above, a redundant description will be avoided herein.

According to various embodiments, the intelligent server 200 may provide the information related to the common utterance to the external device corresponding to the satisfied condition based on the identification that the condition has been satisfied.

For example, when the condition is to identify a new registered voice assistant, the intelligent server 200 may provide the information about the common utterance only to the developer server 430 that has registered the new voice assistant.

For example, when the condition is to identify a new common utterance in a specific category, the intelligent server 200 may provide the information related to the common utterance to all developer servers 430 corresponding to all voice assistants included in the specific category.

For example, when the intelligent server 200 receives a request from the developer server 430, the intelligent server 200 may provide the information about the common utterance only to the developer server 430 that has transmitted the request.

Without being limited to the above description, the intelligent server 200 may provide the information about the common utterance to the developer server 430 corresponding to at least one voice assistant included in the specific category based on the specified condition being satisfied.

Another example of the operation of the intelligent server 200 according to various embodiments will be described. A redundant description to the foregoing description of the intelligent server 200 will be avoided.

According to various embodiments, the intelligent server 200 may identify whether a plurality of voice assistants included in a specific category support a common utterance, and determine whether to provide the common utterance to an external device (for example, a developer server) according to whether the plurality of voice assistants support the common utterance.

FIG. 12 is a flowchart 1200 illustrating an exemplary operation of identifying whether a common utterance is supported and processing the common utterance according to whether the common utterance is supported in the intelligent server 200 according to various embodiments. According to various embodiments, the operations of the electronic device 100 may be performed in a different order, not limited to the order illustrated in FIG. 12. Further, according to various embodiments, more operations than the operations of the electronic device 100 illustrated in FIG. 12 may be performed. Alternatively, at least one operation fewer than the operations of the electronic device 100 illustrated in FIG. 12 may be performed. FIG. 12 will be described below with reference to FIGS. 13 and 14.

FIG. 13 is a diagram illustrating an operation of identifying whether a common utterance is supported and processing the common utterance according to the identification in the intelligent server 200 according to various embodiments. FIG. 14 is a diagram illustrating an exemplary interface for identifying whether a common utterance is supported by the intelligent server 200 according to various embodiments.

According to various embodiments, the intelligent server 200 (for example, the processor of the intelligent server performing an operation based on the utterance data analysis module 512) may identify a plurality of utterances processable by a plurality of voice assistants registered to a first category in operation 1201 and identify at least one common utterance based on the plurality of obtained utterances in operation 1202. Since operations 1201 and 1202 of the intelligent server 200 may be performed in the same manner as operations 602 and 603 of the intelligent server 200 described above, a redundant description will be avoided. The intelligent server 200 may identify information about the utterances processable by the plurality of voice assistants from training DBs 1303, 1305, and 1307 of the utterance DBs 532, 534, and 536 related to the plurality of voice assistants included in the first category 530, as illustrated in FIG. 13. The training DBs 1303, 1305, and 1307 may be DBs that store information about the utterances that the voice assistants corresponding to the training DBs 1303, 1305, and 1307 are trained to process. The intelligent server 200 may identify at least one common utterance among the plurality of voice assistants based on the information about the utterances processable by the plurality of identified voice assistants.

According to various embodiments, the intelligent server 200 (for example, the processor of the intelligent server performing an operation based on the utterance data analysis module 512) may identify whether the obtained common utterance is a supported utterance in the category in operation 1203. A supported utterance in the category may mean an utterance identified as a common utterance among the utterances processable by the voice assistants of the category. The intelligent server 200 may identify information about the supported utterances of the first category 530 from a first training DB 1321 of the DB 521 of the first category 521 illustrated in FIG. 13, and identify (1301 or 1302) whether the at least one common utterance is supported by comparing the identified information about the supported utterances of the identified first category 530 with the information about the obtained at least one common utterance. The first training DB 1321 of the first-category DB 521 may be a DB storing information about utterances identified as common utterances among the utterances processable by the plurality of voice assistants included in the first category 530.

According to various embodiments, the intelligent server 200 (for example, the processor of the intelligent server that performs an operation based on the utterance data analysis module 512) may identify at least a part of at least one common utterance, which has a similarity equal to or greater than a threshold with respect to a prestored supported utterance of the first category 530, as supported (1301), and may identify the other part of the at least one common utterance, which has a similarity less than the threshold, as unsupported (1302). For example, the intelligent server 200 may compare the information about the prestored supported utterance of the first category 530 with the information about the at least one common utterance and identify a common utterance having a similarity equal to or greater than the threshold with respect to the prestored supported utterance of the first category 530 as a supported utterance of the first category 530 (1301). For example, when the prestored supported utterance of the first category is “Order pizza” and the identified common utterance is “Get pizza delivered”, it may be determined that the common utterance has a similarity equal to or greater than a threshold with respect to the prestored supported utterance of the first category, and the common utterance may be stored as a supported utterance of the first category.

As described above, as supported utterances of the first category are identified and stored, voice assistants are capable of processing various utterances.

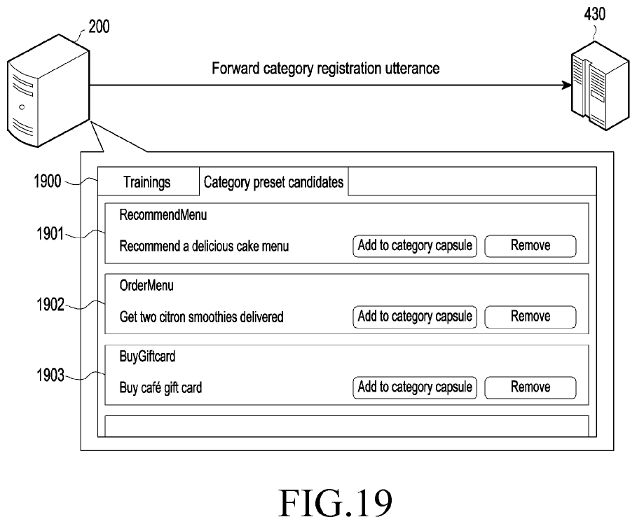

According to various embodiments, when the identified common utterance is identified as a supported utterance of the first category, the intelligent server 200 (for example, the processor of an intelligent server performing an operation based on the utterance data analysis module 512) may store the identified common utterance as a supported utterance of the category in operation 1204 and provide the supported utterance of the category to the external device in operation 1205. For example, as illustrated in FIG. 13, the intelligent server 200 may store at least the part 1301 of the at least one common utterance identified as supported in the first training DB 1321 of the first-category DB 521. The at least part of the at least one common utterance stored in the first training DB 1321 of the first-category DB 521 may be provided to at least one specific voice assistant included in the first category 530 so that the at least one voice assistant may be trained. For example, the stored at least part of the at least one common utterance may be provided to an A^{th} non-training DB 1312 of an A^{th}-utterance DB 1310 corresponding to an A^{th} voice assistant newly included in the first category 530, as illustrated in FIG. 13. The A^{th} voice assistant may be trained with the received at least part of the at least one common utterance so that the A^{th} voice assistant may process the at least part of the at least one common utterance. The at least part of the at least one common utterance provided to the A^{th} non-training DB 1312 may be provided to an A^{th} training DB 1311, for training the A^{th} voice assistant, and information about the at least part of the at least one common utterance provided to the A^{th} training DB 1311 may be provided to the developer server 430. Accordingly, the developer server 430 may determine whether the A^{th} voice assistant supports the at least part of the at least one common utterance identified as supported. When determining that the A^{th} voice assistant supports the at least one common utterance, the A^{th} voice assistant may be trained. The operation of determining whether a common utterance is supported in the developer server 430 will be described later in detail with reference to FIG. 19. For example, the intelligent server 200 may train the A^{th} voice assistant with the at least part of the at least one common utterance based on the stored information about the at least part of the at least one common utterance stored in the A^{th} non-training DB 1312. Without being limited to the above description, the common utterance may be stored in non-training DBs (for example, DBs 1304, 1306, and 1308 in FIG. 13) of the voice assistants included in the category in addition to the newly registered voice assistant (for example, the A^{th} voice assistant), and the voice assistants may be trained with the common utterance, based on the specified condition described with reference to FIGS. 10 and 11 being satisfied.

According to various embodiments, when the intelligent server 200 (e.g., the processor of the intelligent server performing an operation based on the utterance data analysis module 512) identifies the identified common utterance as an unsupported utterance in the first category, the intelligent server 200 may store the common utterance as a supported utterance candidate of the category in operation 1206, and identify whether the common utterance stored as the supported utterance candidate is a supported utterance of the first category in operation 1207. When the intelligent server 200 identifies that the common utterance stored as a supported utterance candidate is a supported utterance of the first category in operation 1207, the intelligent server 200 may perform operation 1205.

According to various embodiments, the intelligent server 200 (e.g., the processor of the intelligent server performing an operation based on the utterance data analysis module 512) may store the remaining part 1302 of the identified at least one common utterance, identified as unsupported in a first non-training DB 1322 of the first-category DB 521, as illustrated in FIG. 13.

According to various embodiments, the intelligent server 200 (e.g., the processor of the intelligent server performing an operation based on the utterance data analysis module 512) may determine whether the remaining part of the at least one common utterance, identified as unsupported and stored in the first non-training DB 1322 is supported. For example, as indicated by reference numerals 1401, 1402, and 1403 in FIG. 14, the intelligent server 200 may display an interface 1400 including utterances (for example, the remaining part of the at least one common utterance, identified as unsupported) stored in the first non-training DB 1322, and graphic elements 1412 and 1413 for determining whether to support the utterances. For example, as illustrated in FIG. 14, the intelligent server 200 may display a common utterance 1411, “Order a delicious cake menu,” which is stored in a non-training DB of a category 1410 “RecommendMenu” and display a first element 1412 used to determine to support the common utterance and a second element 1413 used to determine not to support the common utterance. When the utterance is selected as supported on the interface 1400 (for example, the first element 1412 is selected), the intelligent server 200 may identify the corresponding utterance (for example, the utterance 1411) as supported in the first category (for example, the category 1410). When the utterance is selected as unsupported on the interface (for example, the second element 1413 is selected), the utterance (for example, the utterance 1411) may be deleted from the first non-training DB of the first category (for example, the category 1410), so that no further inquiry may be made as to whether to support the utterance.

According to the above-described operation, the intelligent server 200 may manage the supportability of utterances, so that voice assistants may be managed to provide a speech service corresponding to a specific category.

An example of operations of the intelligent server 200 and the electronic device 100 will be described below. A description redundant to the foregoing descriptions of the intelligent server 200 and the electronic device 100 will be avoided herein.

According to various embodiments, the intelligent server 200 may provide the electronic device 100 with information related to a category corresponding to an utterance received from the electronic device 100.

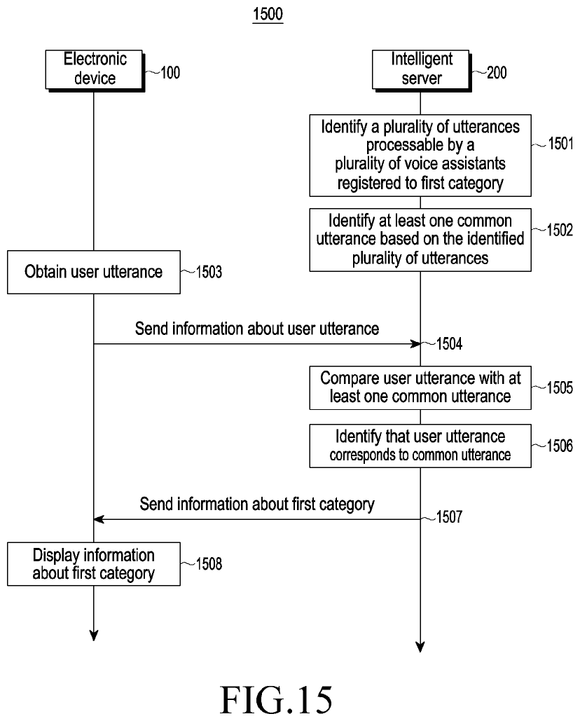

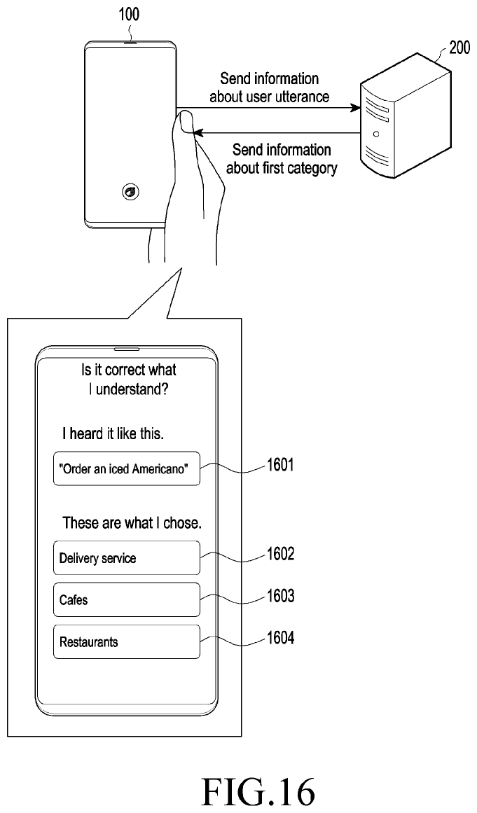

FIG. 15 is a flowchart 1500 illustrating an example of operations of the intelligent server 200 and the electronic device 100 according to various embodiments. According to various embodiments, the operations of the intelligent server 200 and the electronic device 100 may be performed in a different order, not limited to the order illustrated in FIG. 15. Further, according to various embodiments, more operations than the operations of the intelligent server 200 and the electronic device 100 illustrated in FIG. 15 may be performed, or at least one operation fewer than the operations of the intelligent server 200 and the electronic device 100 illustrated in FIG. 15 may be performed. With reference to FIG. 16, FIG. 15 will be described below.

FIG. 16 is a diagram illustrating an exemplary operation of receiving information about a category from the intelligent server 200 by an external device according to various embodiments.

According to various embodiments, the intelligent server 200 may identify a plurality of utterances processable by a plurality of voice assistants registered to a first category in operation 1501 and identify at least one common utterance based on the plurality of utterances in operation 1502. Operations 1501 and 1502 of the intelligent server 200 may be performed in the same manner as the afore-described operations 602 and 603, and operations 1201 and 1202 of the intelligent server 200, and thus a redundant description will not be provided herein.

According to various embodiments, the electronic device 100 may obtain a user utterance in operation 1503. For example, upon recognition of a specified speech input or upon receipt of an input through a hardware key, the electronic device 100 may execute an intelligent app for processing the utterance. The electronic device 100 may receive the user utterance (for example, XX) during execution of the intelligent app.

According to various embodiments, the electronic device 100 may transmit information about the obtained user utterance to the intelligent server 200 in operation 1504. In other words, the intelligent server 200 may receive the information about the user utterance (for example, “Order an iced Americano” 1601 in FIG. 16) from the electronic device 100.

According to various embodiments, the intelligent server 100 may compare the user utterance with at least one common utterance in operation 1505 and identify that the user utterance corresponds to a common utterance in operation 1506.

According to various embodiments, the intelligent server 200 may compare the information about the user utterance received from the electronic device 100 with information about supported utterances in each of the plurality of categories. The intelligent server 200 may identify that information about at least one supported utterance of the first category corresponds to the received information about the user utterance (for example, “Order an iced Americano” 1601 in FIG. 16) among the supported utterances in the plurality of categories based on the comparison result.

According to various embodiments, the intelligent server 200 may compare the information about the user utterance with the information about the supported utterances in the plurality of categories based on similarities as in operation 1203 of the intelligent server 200. Therefore, a redundant description is not provided herein.

According to various embodiments, the intelligent server 200 may transmit information about the first category to the electronic device 100 based on the identification that the user utterance corresponds to the common utterance in operation 1507.

According to various embodiments, the information about the first category may include at least one of information identifying the first category or information about voice assistants included in the category. For example, the information about the first category may include information identifying the first category “Delivery Service” or information about a plurality of assistants included in “Delivery Service”.

According to various embodiments, the electronic device 100 may display the received information about the first category in operation 1508. As illustrated in FIG. 16, the electronic device 100 may display a plurality of categories (for example, “Delivery Service” 1602, “Cafés” 1603, and “Restaurants” 1604) corresponding to the user utterance (for example, “Order an iced Americana” 1601) based on the received information about the first category. Further, the electronic device 100 may display information about the plurality of voice assistants included in the first category based on the received information about the first category, not limited to the above description.

According to various embodiments, the electronic device 100 may display the information about the plurality of categories and receive feedback information from a user on an interface based on the displayed information. For example, the feedback information may include information about the accuracy of the information about the plurality of categories corresponding to the user utterance or information about a user-input category other than the plurality of categories. The feedback information may serve as training data for a voice assistant. An operation of training a voice assistant based on feedback information received from the electronic device 100 will be described later in detail with reference to FIGS. 17, 18 and 19.

Now, a description will be given of an example of operations of the intelligent server 200, the electronic device 100, and the developer server 430. A description redundant to the foregoing descriptions of the intelligent server 200 and the electronic device 100 will be avoided herein.

According to various embodiments, the intelligent server 200 may receive utterances for training a voice assistant from at least one external electronic device 100 (for example, the electronic device 100 and the developer server 430).

FIG. 17 is a flowchart 17000 illustrating an example of operations of the intelligent server 200, the electronic device 100, and the developer server 430 according to various embodiments. According to various embodiments, the operations of the intelligent server 200, the electronic device 100, and the developer server 430 may be performed in a different order, not limited to the operation order illustrated in FIG. 17. Further, according to various embodiments, more operations than the operations of the intelligent server 200, the electronic device 100, and the developer server 430 illustrated in FIG. 17 may be performed, or at least one operation fewer than the operations of the intelligent server 200, the electronic device 100, and the developer server 430 illustrated in FIG. 17 may be performed. With reference to FIGS. 18 and 19, FIG. 17 will be described below.

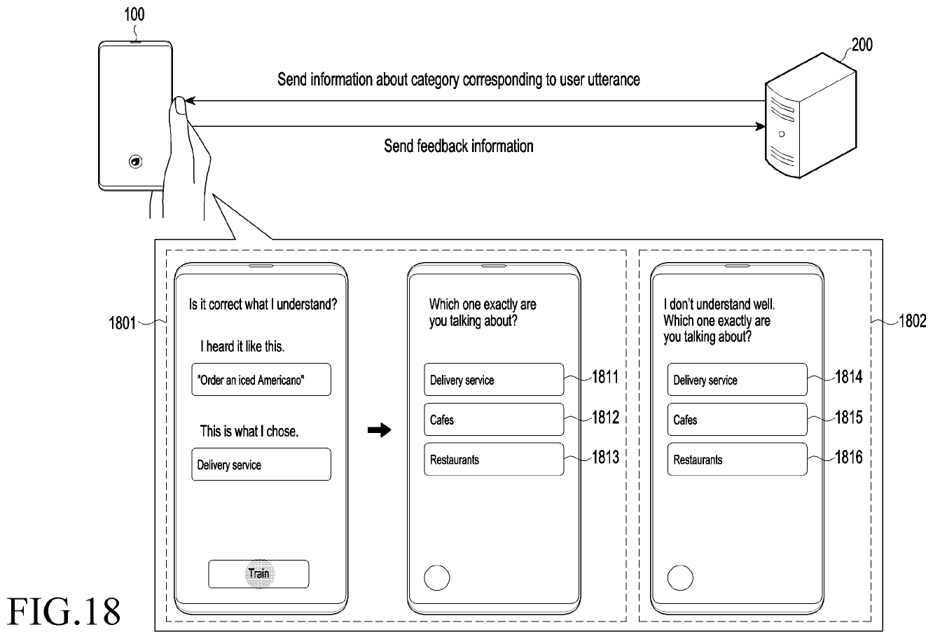

FIG. 18 is a diagram illustrating an exemplary operation of receiving information about an utterance for training from the electronic device 100 in the intelligent server 200 according to various embodiments. FIG. 19 is a diagram illustrating an exemplary operation of receiving information about an utterance for training from the developer server 430 in the intelligent server 200 according to various embodiments.

According to various embodiments, the electronic device 100 may obtain a user utterance in operation 1701 and transmit information about the obtained user utterance to the intelligent server 200 in operation 1702. Operations 1701 and 1702 of the electronic device 100 may be performed in the same manner as the afore-described operations 1503 and 1504 of the electronic device 100, and thus a redundant description will not be provided herein. For example, the electronic device 100 may receive a user utterance “Order an iced Americano” and transmit information about the user utterance to the intelligent server 200.

According to various embodiments, the intelligent server 200 may transmit information about a category corresponding to the user utterance to the electronic device 100 in operation 1703. Operation 1703 of the intelligent server 100 may be performed in the same manner as operations 1505 and 1507 of the intelligent server 100, and thus a redundant description will be avoided herein. For example, the intelligent server 200 may transmit information about the category (for example, Delivery Service) corresponding to the user utterance “Order an iced Americano” to the electronic device 100.

According to various embodiments, the electronic device 100 may transmit feedback information to the intelligent server 200 in operation 1704. For example, the electronic device 100 may transmit, to the intelligent server 200, feedback information including the information about the category corresponding to the user utterance in response to the received information about the category corresponding to the user utterance.

According to various embodiments, the electronic device 100 may select at least one of a plurality of categories corresponding to the user utterance and transmit information about the selected at least one category to the intelligent server 200.

For example, as indicated by reference numeral 1801 in FIG. 18, the electronic device 100 may display an interface including at least one category (for example, Delivery Service 1811, Cafes 1812, and Restaurants 1813) corresponding to the user utterance based on the information about the category corresponding to the user utterance, received from the intelligent server 200. The electronic device 100 may receive an input to a specific category from the user among the at least one category (for example, Delivery Service 1811, Cafes 1812, and Restaurants 1813) displayed on the interface and transmit information about the selected specific category to the intelligent server 200.

For example, as indicated by reference numeral 1802 in FIG. 18, when a category corresponding to the received user utterance has not be identified, the electronic device 100 may receive information about a plurality of categories (for example, Delivery Service 1811, Cafes 1812, and Restaurants 1813) from the intelligent server 200 and display an interface including the received categories (for example, Delivery Service 1811, Cafes 1812, and Restaurants 1813). The electronic device 100 may receive an input to a specific category from the user among the plurality of categories displayed on the interface and transmit information about the selected specific category to the intelligent server 200.

According to various embodiments, the intelligent server 200 may store the user utterance in a DB of the identified category in operation 1705. For example, the intelligent server 200 may identify a specific category (for example, Cafes) corresponding to the user utterance based on the information about the specific category (for example, Cafes) included in the feedback information received from the electronic device 100. The intelligent server 200 may store the information about the user utterance, received from the electronic device 200 in the DB of the identified specific category.

According to various embodiments, the intelligent server 200 may store the information about the user utterance in the training or non-training DB of the identified specific category. For example, the intelligent server 200 may store the information about the user utterance received from the electronic device in the training DB of the identified specific category, so that the plurality of voice assistants in the specific category may process the user utterance. For example, the intelligent server 200 may store the information about the user utterance received from the electronic device in the non-training DB of the identified specific category, so that it may be determined later whether the user utterance is supported in the specific category. The operation of storing the information about the user utterance in the training or non-training DB by the intelligent server 200 may be performed based on similarities between the information about the user utterance and prestored information about supported utterances of the specific category, as in the afore-described operations 1203 to 1207 of the intelligent server 200 (for example, when the information about the user utterance has a similarity equal to or greater than a threshold, the information about the user utterance is stored in the training DB, and when the information about the user utterance has a similarity less the threshold, the information about the user utterance is stored in the non-training DB). Accordingly, a description of operation 1705 of the intelligent server 200 redundant to the description of operations 1203 to 1207 of the intelligent server 200 is avoided herein.

As described above, as the intelligent server 200 receives various types of utterances identifiable as supported in a category from the developer server 430 as well as the electronic device 100, utterances processable by voice assistants registered to the category may become diverse.

According to various embodiments, the developer server 430 may transmit information about a category registration utterance to the intelligent server 200 in operation 1706. The information about the category registration utterance may refer to an utterance to be registered to a specific category. That is, the developer server 430 may request registration of a specific utterance as a supported utterance in the specific category. For example, the developer server 430 may request registration of the utterance “Recommend a delicious cake menu” as a supported utterance of the category “RecommendMenu”, registration of an utterance “Get two citron smoothies delivered” as a supported utterance of a category “OrderMenu”, or registration of an utterance “Buy a gift card” as a supported utterance of a category “BuyGiftcard”.

According to various embodiments, as a specific utterance processable by a first voice assistant in a specific category, registered by a first developer server is not processable by other voice assistants of the specific category, the specific utterance may be classified as unsupported in the specific category. Therefore, the intelligent server 200 may not identify the specific category corresponding to the specific utterance received from the electronic device 100, and thus information about the first voice assistant included in the specific category may not be provided to the electronic device 100. As a consequence, the utilization of the first voice assistant registered by the first developer server 430 may be decreased. Accordingly, the first developer server 430 (or developer) may request registration of the specific utterance processable by the first voice assistant registered to the specific category as supported in the specific category, so that the specific utterance may be processable by the other voice assistants of the specific category, and information about the first voice assistant in the specific category may be provided to the electronic device 100 in response to the information about the specific utterance received from the electronic device 100. Without being limited to the above description, the developer server 430 may request registration of an utterance unprocessable by the voice assistant registered to the specific category as well as an utterance processable by the voice assistant registered to the specific category as supported in the specific category to the intelligent server 200.

According to various embodiments, the intelligent server 200 may store the category registration utterance in a DB of the corresponding category in operation 1707. The intelligent server 200 may store the category registration utterance in the training or non-training DB of the corresponding category as in operation 1705. Accordingly, a description redundant to the description of operation 1705 will be omitted. The intelligent server 200 may display an interface 1900 that displays information about utterances 1901, 1902, and 1903 stored in a non-training DB and is used to determine whether to support the displayed utterances. The intelligent server 200 may receive an input for determining whether to support an utterance on the interface 1900 and store the utterance as a supported utterance of the category in response to the received input. The operation of determining whether to support an utterance in the intelligent server 200 may be performed in the same manner as the afore-described operations 1203 to 1207, and a redundant description is avoided herein.

According to various embodiments, the intelligent server 200 may identify a plurality of utterances related to a plurality of voice utterances included in the category in operation 1708 and identify at least one common utterance based on the obtained plurality of utterances in operation 1709. Operations 1708 and 1709 of the intelligent server 200 may be performed in the same manner as the afore-described operations 603 and 604 and operations 1201 and 1202 of the intelligent server 200, and a redundant description is avoided herein.

An example of the configurations of the intelligent server 200, the electronic device 100, and the developer server 430 will be described below. The following description of devices in a network environment 2000 may be applied to the intelligent server 200, the electronic device 100, and the developer server 430.

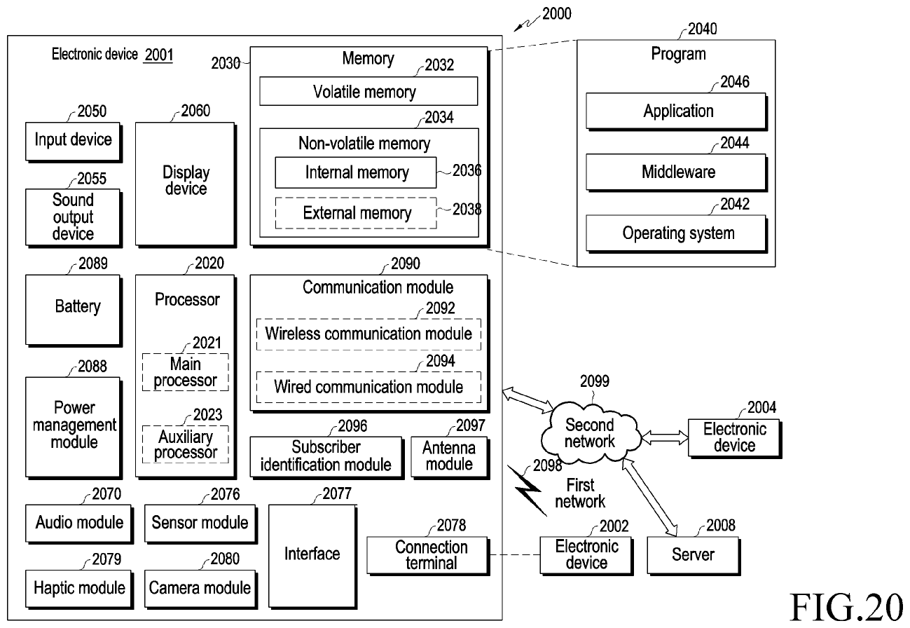

FIG. 20 is a block diagram illustrating an electronic device 2001 in a network environment 2000 according to various embodiments. Referring to FIG. 20, the electronic device 2001 in the network environment 2000 may communicate with an electronic device 2002 via a first network 2098 (e.g., a short-range wireless communication network), or an electronic device 2004 or a server 2008 via a second network 2099 (e.g., a long-range wireless communication network). According to an embodiment, the electronic device 2001 may communicate with the electronic device 2004 via the server 2008. According to an embodiment, the electronic device 2001 may include a processor 2020, memory 2030, an input device 2050, a sound output device 2055, a display device 2060, an audio module 2070, a sensor module 2076, an interface 2077, a haptic module 2079, a camera module 2080, a power management module 2088, a battery 2089, a communication module 2090, a subscriber identification module (SIM) 2096, or an antenna module 2097. In some embodiments, at least one (e.g., the display device 2060 or the camera module 2080) of the components may be omitted from the electronic device 2001, or one or more other components may be added in the electronic device 2001. In some embodiments, some of the components may be implemented as single integrated circuitry. For example, the sensor module 2076 (e.g., a fingerprint sensor, an iris sensor, or an illuminance sensor) may be implemented as embedded in the display device 2060 (e.g., a display).

The processor 2020 may execute, for example, software (e.g., a program 2040) to control at least one other component (e.g., a hardware or software component) of the electronic device 2001 coupled with the processor 2020, and may perform various data processing or computation. According to one embodiment, as at least part of the data processing or computation, the processor 2020 may load a command or data received from another component (e.g., the sensor module 2076 or the communication module 2090) in volatile memory 2032, process the command or the data stored in the volatile memory 2032, and store resulting data in non-volatile memory 2034. According to an embodiment, the processor 2020 may include a main processor 2021 (e.g., a central processing unit (CPU) or an application processor (AP)), and an auxiliary processor 2023 (e.g., a graphics processing unit (GPU), an image signal processor (ISP), a sensor hub processor, or a communication processor (CP)) that is operable independently from, or in conjunction with, the main processor 2021. Additionally or alternatively, the auxiliary processor 2023 may be adapted to consume less power than the main processor 2021, or to be specific to a specified function. The auxiliary processor 2023 may be implemented as separate from, or as part of the main processor 2021.

The auxiliary processor 2023 may control at least some of functions or states related to at least one component (e.g., the display device 2060, the sensor module 2076, or the communication module 2090) among the components of the electronic device 2001, instead of the main processor 2021 while the main processor 2021 is in an inactive (e.g., sleep) state, or together with the main processor 2021 while the main processor 2021 is in an active state (e.g., executing an application). According to an embodiment, the auxiliary processor 2023 (e.g., an image signal processor or a communication processor) may be implemented as part of another component (e.g., the camera module 2080 or the communication module 2090) functionally related to the auxiliary processor 2023.

The memory 2030 may store various data used by at least one component (e.g., the processor 2020 or the sensor module 2076) of the electronic device 2001. The various data may include, for example, software (e.g., the program 2040) and input data or output data for a command related thererto. The memory 2030 may include the volatile memory 2032 or the non-volatile memory 2034.

The program 2040 may be stored in the memory 2030 as software, and may include, for example, an operating system (OS) 2042, middleware 2044, or an application 2046.

The input device 2050 may receive a command or data to be used by other component (e.g., the processor 2020) of the electronic device 2001, from the outside (e.g., a user) of the electronic device 2001. The input device 2050 may include, for example, a microphone, a mouse, a keyboard, or a digital pen (e.g., a stylus pen).

The sound output device 2055 may output sound signals to the outside of the electronic device 2001. The sound output device 2055 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 2060 may visually provide information to the outside (e.g., a user) of the electronic device 2001. The display device 2060 may include, for example, a display, a hologram device, or a projector and control circuitry to control a corresponding one of the display, hologram device, and projector. According to an embodiment, the display device 2060 may include touch circuitry adapted to detect a touch, or sensor circuitry (e.g., a pressure sensor) adapted to measure the intensity of force incurred by the touch.

The audio module 2070 may convert a sound into an electrical signal and vice versa. According to an embodiment, the audio module 2070 may obtain the sound via the input device 2050, or output the sound via the sound output device 2055 or a headphone of an external electronic device (e.g., an electronic device 2002) directly (e.g., wiredly) or wirelessly coupled with the electronic device 2001.

The sensor module 2076 may detect an operational state (e.g., power or temperature) of the electronic device 2001 or an environmental state (e.g., a state of a user) external to the electronic device 2001, and then generate an electrical signal or data value corresponding to the detected state. According to an embodiment, the sensor module 2076 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 2077 may support one or more specified protocols to be used for the electronic device 2001 to be coupled with the external electronic device (e.g., the electronic device 2002) directly (e.g., wiredly) or wirelessly. According to an embodiment, the interface 2077 may include, for example, a high definition multimedia interface (HDMI), a universal serial bus (USB) interface, a secure digital (SD) card interface, or an audio interface.

A connecting terminal 2078 may include a connector via which the electronic device 2001 may be physically connected with the external electronic device (e.g., the electronic device 2002). According to an embodiment, the connecting terminal 2078 may include, for example, a HDMI connector, a USB connector, a SD card connector, or an audio connector (e.g., a headphone connector).

The haptic module 2079 may convert an electrical signal into a mechanical stimulus (e.g., a vibration or a movement) or electrical stimulus which may be recognized by a user via his tactile sensation or kinesthetic sensation. According to an embodiment, the haptic module 2079 may include, for example, a motor, a piezoelectric element, or an electric stimulator.

The camera module 2080 may capture a still image or moving images. According to an embodiment, the camera module 2080 may include one or more lenses, image sensors, image signal processors, or flashes.

The power management module 2088 may manage power supplied to the electronic device 2001. According to one embodiment, the power management module 2088 may be implemented as at least part of, for example, a power management integrated circuit (PMIC).

The battery 2089 may supply power to at least one component of the electronic device 2001. According to an embodiment, the battery 2089 may include, for example, a primary cell which is not rechargeable, a secondary cell which is rechargeable, or a fuel cell.

The communication module 2090 may support establishing a direct (e.g., wired) communication channel or a wireless communication channel between the electronic device 2001 and the external electronic device (e.g., the electronic device 2002, the electronic device 2004, or the server 2008) and performing communication via the established communication channel. The communication module 2090 may include one or more communication processors that are operable independently from the processor 2020 (e.g., the application processor (AP)) and supports a direct (e.g., wired) communication or a wireless communication. According to an embodiment, the communication module 2090 may include a wireless communication module 2092 (e.g., a cellular communication module, a short-range wireless communication module, or a global navigation satellite system (GNSS) communication module) or a wired communication module 2094 (e.g., a local area network (LAN) communication module or a power line communication (PLC) module). A corresponding one of these communication modules may communicate with the external electronic device via the first network 2098 (e.g., a short-range communication network, such as Bluetooth™, wireless-fidelity (Wi-Fi) direct, or infrared data association (IrDA)) or the second network 2099 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 2092 may identify and authenticate the electronic device 2001 in a communication network, such as the first network 2098 or the second network 2099, using subscriber information (e.g., international mobile subscriber identity (IMSI)) stored in the subscriber identification module 2096.

The antenna module 2097 may transmit or receive a signal or power to or from the outside (e.g., the external electronic device) of the electronic device 2001. According to an embodiment, the antenna module 2097 may include an antenna including a radiating element composed of a conductive material or a conductive pattern formed in or on a substrate (e.g., PCB). According to an embodiment, the antenna module 2097 may include a plurality of antennas. In such a case, at least one antenna appropriate for a communication scheme used in the communication network, such as the first network 2098 or the second network 2099, may be selected, for example, by the communication module 2090 (e.g., the wireless communication module 2092) from the plurality of antennas. The signal or the power may then be transmitted or received between the communication module 2090 and the external electronic device via the selected at least one antenna. According to an embodiment, another component (e.g., a radio frequency integrated circuit (RFIC)) other than the radiating element may be additionally formed as part of the antenna module 2097.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 2001 and the external electronic device 2004 via the server 2008 coupled with the second network 2099. Each of the electronic devices 2002 and 2004 may be a device of a same type as, or a different type, from the electronic device 2001. According to an embodiment, all or some of operations to be executed at the electronic device 2001 may be executed at one or more of the external electronic devices 2002, 2004, or 2008. For example, if the electronic device 2001 should perform a function or a service automatically, or in response to a request from a user or another device, the electronic device 2001, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 2001. The electronic device 2001 may provide the outcome, with or without further processing of the outcome, as at least part of a reply to the request. To that end, a cloud computing, distributed computing, or client-server computing technology may be used, for example.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 2040) including one or more instructions that are stored in a storage medium (e.g., internal memory 2036 or external memory 2038) that is readable by a machine (e.g., the electronic device 2001). For example, a processor (e.g., the processor 2020) of the machine (e.g., the electronic device 2001) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

According to various embodiments, an operation of controlling an electronic device may include registering a plurality of voice assistants to a first category, the plurality of voice assistants including information about a plurality of utterances capable of being processed and a plurality of pieces of processing result information corresponding to the plurality of utterances, identifying the plurality of utterances capable of being processed by the plurality of voice assistants registered to the first category, identifying at least one common utterance among the identified plurality of utterances, the at least one common utterance satisfying a specific condition related a similarity, receiving a request for registering a first voice assistant to the first category from an external device, and providing information related to the at least one common utterance to the external device, based on the request.

According to various embodiments, the operation may further include receiving a user utterance from a first external device, and when the received user utterance corresponds to a first utterance among the plurality of utterances, obtaining first processing result information generated by processing the received user utterance by a second voice assistant capable of processing the first utterance among the plurality of voice assistants.

According to various embodiments, the at least one common utterance may be an utterance processable by each of the plurality of voice assistants, and the at least one common utterance may be the same utterances among the plurality of utterances or each of the at least one common utterance may be an utterance having a similarity equal to or greater than a threshold.

According to various embodiments, based on the information related to the at least one common utterance being provided to the external device, the at least one common utterance may be processable by the first voice assistant.

According to various embodiments, the operation may further include identifying whether the at least one common utterance corresponds to an utterance supported by the first category, and when the at least one common utterance corresponds to the utterance supported by the first category, storing the at least one common utterance as a supported utterance of the first category.

According to various embodiments, the operation may further include identifying at least one prestored utterance supported by the first category, the at least one prestored utterance supported by the first category being an utterance identified as a common utterance among the plurality of utterances, and when at least a part of the at least one prestored utterance supported by the first category corresponds to the at least one common utterance, identifying the at least one common utterance as the utterance supported by the first category.

According to various embodiments, the operation may further include, when the at least one common utterance does not correspond to the utterance supported by the first category, identifying whether the at least one common utterance is supported, and when it is identified that the at least one common utterance is supported, storing the at least one common utterance as the utterance supported by the first category.

According to various embodiments, the identifying of the plurality of utterances capable of being processed by the plurality of voice assistants registered to the first category may include receiving a first utterance to be registered as an utterance supported by the first category from the external device, and identifying the received first utterance as the plurality of utterances.

According to various embodiments, the identifying of the plurality of utterances processable by the plurality of voice assistants registered to the first category may include receiving a user utterance from a first external device, receiving category information related to the user utterance from the first external device, identifying a category corresponding to the user utterance based on the received category information, and when the identified category corresponding to the user utterance is the first category, identifying the user utterance as the plurality of utterances.

According to various embodiments, the operation may further include storing the at least one common utterance as an utterance supported by the first category, receiving a user utterance from a first external device, comparing the received user utterance with the at least one common utterance, and when it is identified that the received user utterance corresponds to the at least one common utterance based on a result of the comparison, providing information related to the first category to the first external device.

According to various embodiments, an operation of controlling an electronic device may include registering a plurality of voice assistants to a first category, the plurality of voice assistants including information about a plurality of utterances capable of being processed and a plurality of pieces of processing result information corresponding to the plurality of utterances, identifying the plurality of utterances capable of being processed by the plurality of voice assistants registered to the first category, identifying at least one common utterance corresponding to the first category based on the identified plurality of utterances, identifying that a specified condition for sharing the at least one common utterance has been satisfied, and based on the identification that the specific condition for sharing the at least one common utterance has been satisfied, providing information related to the at least one common utterance to at least a part of a plurality of external devices corresponding to the plurality of voice assistants registered to the first category.

According to various embodiments, the operation may further include, upon receipt of a request for registering a first voice assistant to the first category from an external device, identifying that the specific condition has been satisfied.

According to various embodiments, the operation may further include, upon receipt of a request for the information related to the at least one common utterance from an external device, identifying that the specific condition has been satisfied. The at least one external device is associated with the plurality of assistants registered to the first category.

According to various embodiments, the operation may further include, when the identified at least common utterance is different from a prestored supported utterance of the first category, identifying that the specific condition has been satisfied.

According to various embodiments, an electronic device may include a communication circuit, a processor, and a memory. The memory may store instructions which when executed, cause the processor to register a plurality of voice assistants to a first category, the plurality of voice assistants including information about a plurality of utterances capable of being processed and a plurality of pieces of processing result information corresponding to the plurality of utterances, identify the plurality of utterances capable of being processed by the plurality of voice assistants registered to the first category, identify at least one common utterance among the identified plurality of utterances, the at least one common utterance satisfying a specific condition related a similarity, control the communication circuit to receive a request for registering a first voice assistant to the first category from an external device, and control the communication circuit to transmit information related to the at least one common utterance to the external device, based on the request.

According to various embodiments, the instructions may cause the processor to control the communication circuit to receive a user utterance from a first external device, and when the received user utterance corresponds to a first utterance among the plurality of utterances, obtain first processing result information generated by processing the received user utterance by a second voice assistant capable of processing the first utterance among the plurality of voice assistants.

According to various embodiments, the at least one common utterance may be an utterance processable by each of the plurality of voice assistants, and the at least one common utterance may be same utterances among the plurality of utterances or each of the at least one common utterance may be an utterance having a similarity equal to or greater than a threshold.

According to various embodiments, based on the information related to the at least one common utterance being provided to the external device, the at least one common utterance is processable by the first voice assistant.

According to various embodiments, the instructions may cause the processor to identify whether the at least one common utterance corresponds to an utterance supported by the first category, and when the at least one common utterance corresponds to the utterance supported by the first category, store the at least one common utterance as the utterance supported by the first category.

According to various embodiments, the instructions may cause the processor to identify at least one prestored utterance supported by the first category, the at least one prestored utterance supported by the first category being an utterance identified as a common utterance among the plurality of utterances, and when at least a part of the at least one prestored utterance supported by the first category corresponds to the at least one common utterance, identify the at least one common utterance as the utterance supported by the first category.

What is claimed is:

1. A method of controlling an electronic device, the method comprising:
registering a plurality of voice assistants to a first category, the plurality of voice assistants including processing information about a plurality of utterances processable by the plurality of voice assistants and result information corresponding to responses for the plurality of utterances;
identifying the plurality of utterances processable by the plurality of voice assistants registered to the first category;
identifying at least one common utterance, among the identified plurality of utterances, that satisfies a specific condition related to a similarity;
receiving a request for registering a first voice assistant to the first category from an external device; and
providing information related to the at least one common utterance to the external device based on the request.

2. The method according to claim 1, further comprising:
receiving a user utterance from a first external device; and
when the received user utterance corresponds to a first utterance among the plurality of utterances, obtaining first result information generated by processing the received user utterance by a second voice assistant capable of processing the first utterance among the plurality of voice assistants.

3. The method according to claim 2, wherein:
the at least one common utterance is an utterance processable by each of the plurality of voice assistants, and
the at least one common utterance is a same utterance for each of the plurality of voice assistants or each of the at least one common utterance is an utterance having a similarity equal to or greater than a threshold.

4. The method according to claim 1, wherein based on the information related to the at least one common utterance provided to the external device, the at least one common utterance is processable by the first voice assistant.

5. The method according to claim 1, further comprising:
identifying whether the at least one common utterance corresponds to an utterance supported by the first category; and
when the at least one common utterance corresponds to the utterance supported by the first category, storing the at least one common utterance as a supported utterance of the first category.

6. The method according to claim 5, further comprising:
identifying at least one prestored utterance supported by the first category, the at least one prestored utterance supported by the first category is an utterance identified as a common utterance among the plurality of utterances; and
when at least a part of the at least one prestored utterance identified as the common utterance supported by the first category corresponds to the at least one common utterance, identifying the at least one common utterance as supported by the first category.

7. The method according to claim 5, further comprising:
when the at least one common utterance does not correspond to the utterance supported by the first category, identifying whether the at least one common utterance is supported; and
when it is identified that the at least one common utterance is supported, storing the at least one common utterance as supported by the first category.

8. The method according to claim 1, wherein the identifying of the plurality of utterances processable by the plurality of voice assistants registered to the first category comprises:
receiving a first utterance to be registered as an utterance supported by the first category from the external device; and
identifying the received first utterance as one of the plurality of utterances.

9. The method according to claim 1, wherein the identifying of the plurality of utterances processable by the plurality of voice assistants registered to the first category comprises:
receiving a user utterance from a first external device;
receiving category information related to the user utterance from the first external device;
identifying a category corresponding to the user utterance based on the received category information; and
when the identified category corresponding to the user utterance is the first category, identifying the user utterance as one of the plurality of utterances.

10. The method according to claim 1, further comprising:
storing the at least one common utterance as an utterance supported by the first category;
receiving a user utterance from a first external device;
comparing the received user utterance with the at least one common utterance; and
when the received user utterance corresponds to the at least one common utterance, providing information related to the first category to the first external device.

11. An electronic device comprising:
a communication circuit;
a processor; and
a memory,
wherein the memory stores instructions configured, when executed, to cause the processor to:
register a plurality of voice assistants to a first category, the plurality of voice assistants including processing information about a plurality of utterances processable by the plurality of voice assistants and a plurality of pieces of processing result information corresponding to the plurality of utterances;
identify the plurality of utterances processable by the plurality of voice assistants registered to the first category;
identify at least one common utterance, among the identified plurality of utterances, that satisfies a specific condition related to a similarity;
control the communication circuit to receive a request for registering a first voice assistant to the first category from an external device; and
control the communication circuit to transmit information related to the at least one common utterance to the external device, based on the request.

12. The electronic device according to claim 11, wherein the instructions are configured to cause the processor to:
control the communication circuit to receive a user utterance from a first external device; and
when the received user utterance corresponds to a first utterance among the plurality of utterances, obtain first result information generated by processing the received user utterance by a second voice assistant capable of processing the first utterance among the plurality of voice assistants.

13. The electronic device according to claim 12, wherein:
the at least one common utterance is an utterance processable by each of the plurality of voice assistants, and
the at least one common utterance is a same utterance for each of the plurality of voice assistants or each of the at least one common utterance is an utterance having a similarity equal to or greater than a threshold.

14. The electronic device according to claim 11, wherein based on the information related to the at least one common utterance provided to the external device, the at least one common utterance is processable by the first voice assistant.

15. The electronic device according to claim 12, wherein the instructions are configured to cause the processor to:
identify whether the at least one common utterance corresponds to an utterance supported by the first category; and
when the at least one common utterance corresponds to the utterance supported by the first category, store the at least one common utterance as a supported utterance of the first category.

16. The electronic device according to claim 15, wherein the instructions are further configured to cause the processor to:
identify at least one prestored utterance supported by the first category, the at least one prestored utterance supported by the first category is an utterance identified as a common utterance among the plurality of utterances; and
when at least a part of the at least one prestored utterance identified as the common utterance supported by the first category corresponds to the at least one common utterance, identify the at least one common utterance as supported by the first category.

17. The electronic device according to claim 15, wherein the instructions are further configured to cause the processor to:
when the at least one common utterance does not correspond to the utterance supported by the first category, identifying whether the at least one common utterance is supported; and
when it is identified that the at least one common utterance is supported, storing the at least one common utterance as supported by the first category.

18. The electronic device according to claim 11, wherein the instructions that are configured to cause the processor to identify of the plurality of utterances processable by the plurality of voice assistants registered to the first category comprises instructions that are configured to cause the processor to:
receive a first utterance to be registered as an utterance supported by the first category from the external device; and
identify the received first utterance as one of the plurality of utterances.

19. The electronic device according to claim 11, wherein the instructions that are configured to cause the processor to identify of the plurality of utterances processable by the plurality of voice assistants registered to the first category comprises instructions that are configured to cause the processor to:
receive a user utterance from a first external device;
receive category information related to the user utterance from the first external device;
identify a category corresponding to the user utterance based on the received category information; and
when the identified category corresponding to the user utterance is the first category, identify the user utterance as one of the plurality of utterances.

20. The electronic device according to claim 11, wherein the instructions are further configured to cause the processor to:
store the at least one common utterance as an utterance supported by the first category;
receive a user utterance from a first external device;
compare the received user utterance with the at least one common utterance; and
when the received user utterance corresponds to the at least one common utterance, provide information related to the first category to the first external device.
